(19) United States
(12) Patent Application Publication
(10) Pub. No.: US 2008/0227018 A1
(43) Pub. Date: Sep. 18, 2008

(54) TONER FOR DEVELOPING A LATENT ELECTROSTATIC IMAGE, AND IMAGE FORMING METHOD AND APPARATUS USING THE TONER

(76) Inventors: Junichi Awamura, Numazu-shi (JP); Osamu Uchinokura, Mishima-shi (JP); Akinori Saitoh, Numazu-shi (JP); Masahide Yamada, Numazu-shi (JP); Tomomi Suzuki, Numazu-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/046,941

(22) Filed: Mar. 12, 2008

(30) Foreign Application Priority Data
Mar. 16, 2007 (JP) 2007-068260
Oct. 1, 2007 (JP) 2007-257148

(51) Int. Cl. G03G 9/00

(52) U.S. Cl. 430/110.4; 430/137.14

(57) ABSTRACT

To provide a toner containing toner particles, wherein each toner particle contains at least: a releasing agent having an average dispersed particle diameter of 0.1 to 0.5 μm; and a modified layered inorganic mineral in which at least a part of ions present in between layers of a layered inorganic mineral is replaced with an organic ion, wherein the toner has a ratio A/B of 0.2 to 2.0 where A denotes the average dispersed particle diameter of the releasing agent and B denotes an average dispersed particle diameter of the modified layered inorganic mineral, or a proportion of the dispersed particles of the releasing agent having a diameter of 1 μm or more in the dispersed particles of the releasing agent having a diameter of 0.5 μm or more is 20% by number or less.

### BACKGROUND OF THE INVENTION

1. Field of the Invention

The present invention relates to a toner used for a developer for developing a latent electrostatic image in electrophotography, electrostatic recording, electrostatic printing and the like, and an electrophotographic developing apparatus using the toner. Particularly, the present invention relates to an electrophotographic toner used in copying machines using a direct or indirect electrophotographic developing system, laser printers, plain paper facsimiles and the like, and a method for forming images.

2. Description of the Related Art

In recent years, strong demands for high-quality images from markets spur the development of electrophotographic apparatuses suitable therefor and toner developers used therein. Toners conforming to high-quality images are essentially those having a uniform particle size. A uniform toner particle size and a sharp toner particle size distribution result in a uniform behavior of individual toner particles on development and a remarkable improvement in fine dot reproducibility.

However, toners having a smaller and more uniform particle size than conventional ones cause difficulty in cleanability. Especially, blade cleaning cannot stably clean toners having a small and uniform particle size. Under such situations, various types of methods have been proposed to improve cleanability by devising toners. One of them is a method of satisfying the requirement by changing a toner shape from a spherical shape to a nonspherical shape. Making the toner into a nonspherical shape decreases the fluidity of a toner powder and brings about easy damming up by blade cleaning. However, an excessively high degree of the deformation of a toner instabilizes the behavior of the toner on development and the like, and deteriorates the fine dot reproducibility.

While making a toner into a nonspherical shape certainly improves the reliability of the toner on cleaning as described above, the toner causes trouble in fixing. That is, making the toner into a nonspherical shape reduces the toner filling density in a toner layer on a transfer material before fixing, reduces the thermal conductivity in the toner layer in fixing, and deteriorates the low-temperature fixability. Particularly when the pressure in fixing is lower than conventional ones, the thermal conductivity further worsens, inhibiting the low-temperature fixing.

Japanese Patent Application Laid-Open (JP-A) No. 11-133665 proposes a toner containing a polyester having a Wadell practical sphericity of 0.90 to 1.00. However, since the toner is substantially spherical, the proposal does not solve the problem of the toner cleanability described above.

Although methods for manufacturing polymerized toners involve an emulsion polymerization method and a dissolution suspension method, which can relatively easily make toners into a nonspherical shape, in addition to a suspension polymerization method, since even the emulsion polymerization method has difficulty in completely removing styrene monomers and removing emulsifiers and dispersants, and especially the environmental problems are recently highlighted, toners have grave problems. Making the toner shape uneven easily causes such problems that the toner causes the contamination of a photoreceptor and that the toner adheres to a fixing roller, due to a weak adhesion of silica added as a fluidizer in the dents of the toner and a movement of silica to the dents thereof in use. Although the dissolution suspension method has a merit that a polyester resin, which makes a low-temperature fixing possible, can be used, since high molecular components are added in a process in which resins and colorants are dissolved or dispersed in a solvent during the control and production of a polymer to widen the releasing width for achieving oilless fixing, there easily arises a problem with productivity due to an increased liquid viscosity. Then, these problems have not yet been solved. Particularly in the dissolution suspension method, in Japanese Patent Application Laid-Open (JP-A) No. 09-15903, although improvement in cleaning is attempted by making the toner surface shape of a spherical and uneven shape, the toner lacks the electrostatic stability because of an amorphous toner having no regularity, and a high molecular design to secure the basic durable quality and the releasability is not made, providing no toner having a satisfiable quality.

Japanese Patent Application Laid-Open (JP-A) No. 2005-49858 recently proposes a toner resin particle having a shape exhibiting an excellent blade cleanability and having a wide fixing temperature width. However, actually, both the cleanability and the low-temperature fixability are insufficiently satisfied simultaneously.

Although a large amount of a charge control agent is added for control being charging of a toner, in a method for manufacturing a toner, the so-called crushing method, in which a mixture obtained by adding colorants and optionally additives to a thermoplastic resin as a binder resin is melted and kneaded and then, crushed and classified, there arise such trouble that (1) making the particle size small has a limitation and making high-quality images becomes difficult, (2) although respective particles can be homogeneously dispersed by conducting kneading followed by crushing, it is impossible to control arranging of materials within a particle, and (3) an increase in the amount of a charge control agent to impart the chargeability generates side-effects on filming/fixability.

Modified layered inorganic minerals in which part of ions present interlayery in a layered inorganic mineral is modified with an organic ion are recently proposed, but these have the problems described above (see Japanese Patent Application Laid-Open (JP-A) Nos. 2003-515795, 2006-500605, 2006-503313 and 2003-202708).

### BRIEF SUMMARY OF THE INVENTION

The problems to be solved by the present invention are as follows:
(1) To provide a toner and an image forming apparatus which can provide a high reliability in cleaning;
(2) To provide a toner and an image forming apparatus which are excellent in low-temperature fixability;
(3) To provide a toner and an image forming apparatus which can solve the problems (1) and (2) simultaneously;
(4) To provide a toner and an image forming apparatus which have an excellent transfer efficiency, give little residual toner after transfer and can provide high-quality images;
(5) To provide a toner which satisfies both the charging stability and the low-temperature fixability simultaneously; and
(6) To provide a novel toner which has a low power consumption, and satisfies both a high transferability and an OHP transmissivity necessary for color images simultaneously in a high level.

The present inventors have achieved the present invention to solve the problems described above.

That is, according to the present invention, a toner and a method and an apparatus to form images described hereinafter are provided:
(1) A toner for developing a latent electrostatic image, containing:

toner particles,

wherein each toner particle contains at least:

a releasing agent having an average dispersed particle diameter of 0.1 μm to 0.5 μm; and

a modified layered inorganic mineral in which at least a part of ions present in between layers of a layered inorganic mineral is replaced with an organic ion,

wherein a content of the releasing agent is 1% by mass to 10% by mass, and the toner has a ratio A/B of 0.2 to 2.0 where A denotes the average dispersed particle diameter of the releasing agent and B denotes an average dispersed particle diameter of the modified layered inorganic mineral, and

wherein the toner is obtained by a method containing:

dissolving or dispersing at least a binder resin and/or a precursor of a binder resin, a colorant, the releasing agent, and the modified layered inorganic mineral in an organic solvent so as to prepare an oil phase;

dispersing the oil phase in an aqueous medium so as to prepare an emulsified dispersion; and

removing the solvent from the emulsified dispersion so as to yield the toner particles.
(2) A toner for developing a latent electrostatic image, containing:

toner particles,

wherein each toner particle contains at least:

a releasing agent having an average dispersed particle diameter of 0.1 μm to 0.5 μm, wherein a proportion of the dispersed particles of the releasing agent having a diameter of 1 μm or more in the dispersed particles of the releasing agent having a diameter of 0.5 μm or more is 20% by number or less,

wherein the toner is obtained by a method containing:

dissolving or dispersing at least a binder resin and/or a precursor of a binder resin, a colorant, the releasing agent, and a modified layered inorganic mineral in which at least a part of ions present in between layers of a layered inorganic mineral is replaced with an organic ion, in an organic solvent so as to prepare an oil phase;

dispersing the oil phase in an aqueous medium so as to prepare an emulsified dispersion; and

removing the solvent from the emulsified dispersion so as to yield the toner particles.
(3) A toner for developing a latent electrostatic image, containing:

toner particles,

wherein each toner particle contains at least:

a releasing agent having an average dispersed particle diameter of 0.1 μm to 0.5 μm, wherein a proportion of the dispersed particles of the releasing agent having a diameter of 1 μm or more in the dispersed particles of the releasing agent having a diameter of 0.5 μm or more is 20% by number or less,

wherein the toner is obtained by a method containing:

dissolving or dispersing at least a polymer having a site reactive with a compound having an active hydrogen group, a binder resin and/or a precursor of a binder resin, a colorant, the releasing agent, a kneaded composite of the binder resin and a modified layered inorganic mineral in which at least a part of ions present in between layers of a layered inorganic mineral is replaced with an organic ion, in an organic solvent so as to prepare an oil phase;

dispersing the oil phase in an aqueous medium containing resin fine particles so as to allow the polymer to react; and

removing the solvent after or during the reaction so as to yield the toner particles.
(4) The toner according to any one of (1) to (3), wherein the modified layered inorganic mineral has an average dispersed particle diameter of 0.1 μm to 0.55 μm.
(5) The toner according to any of (1) or (2), wherein the modified layered inorganic mineral is added to the oil phase as a kneaded composite with the binder resin, and the modified layered inorganic mineral has an average dispersed particle diameter of 0.1 μm to 0.55 μm in the kneaded composite.
(6) The toner according to any one of claims 1 to 5, wherein the precursor of the binder resin is a modified polyester resin, and

wherein a compound which is capable of being elongated or crosslinked with the modified polyester resin is dissolved in the oil phase, the oil phase is dispersed in the aqueous medium in the presence of fine particle dispersant so as to prepare the emulsified dispersion, the modified polyester is allowed to proceed a crosslinking reaction and/or an elongation reaction in the emulsified dispersion, and the organic solvent is removed from the emulsified dispersion so as to yield the toner particles.
(7) The toner according to any one of (1) to (6), wherein the toner comprises 0.05% by mass to 5.0% by mass of the modified layered inorganic mineral.
(8) The toner according to any one of (1) to (7), wherein the modified layered inorganic mineral is a layered inorganic mineral in which at least a part of metallic cations present in between layers of the layered inorganic mineral is replaced with an organic cation.
(9) The toner according to any one of (1) to (8), wherein the toner has a volume average particle diameter Dv of 3.0 μm to 7.0 μm, and a ratio Dv/Dn of 1.00 to 1.30, where Dv denotes the volume average particle diameter and Dn denotes a number average particle diameter.
(10) The toner according to any one of (1) to (9), wherein the dispersed particles of the releasing agent having a particle diameter of 0.5 μm or more has an aspect ratio of the particle of 0.800 or less, and a proportion of the dispersed particles of the releasing agent having a particle diameter of 1 μm or more in the dispersed particles of the releasing agent having a particle diameter of 0.5 μm or more is 20% by number or less.
(11) The toner according to any one of (2) to (10), wherein the toner contains 1% by mass to 10% by mass of the releasing agent.
(12) The toner according to any one of (1) to (11), wherein the modified layered inorganic mineral is added as a kneaded composite with the binder resin to the oil phase, the modified layered inorganic mineral has an average dispersed particle diameter of 0.1 μm to 0.55 μm in the kneaded composite, and the modified layered inorganic mineral having a particle diameter of 1 μm or more accounts for 15% by volume or less in the kneaded composite.
(13) The toner according to any one of (1) to (12), wherein the toner has an average circularity of 0.93 to 0.97.
(14) The toner according to any one of (1) to (13), wherein the toner particles having a circularity of 0.950 or less account for 20% by number to 80% by number in the entire toner particles.
(15) The toner according to any one of (1) to (14), wherein the toner has a shape factor SF-1 of 110 to 200 and a shape factor SF-2 of 110 to 300.
(16) The toner according to any one of (1) to (15), wherein in the modified layered inorganic mineral, the organic ion for replacing is a quaternary ammonium ion.
(17) The toner according to any one of (1) to (16), wherein the toner has a volume average particle diameter Dv of 3 μm to 7 μm.
(18) The toner according to any one of (1) to (17), wherein the toner has a ratio Dv/Dn of 1.20 or less, where Dv denotes a volume average particle diameter and Dn denotes a number average particle diameter.
(19) The toner according to any one of (1) to (18), wherein the toner particles having a diameter of 2 μm or less account for 1% by number to 20% by number in the entire toner particles.
(20) The toner according to any one of (1) to (19), wherein the binder resin comprises a polyester resin.
(21) The toner according to (20), wherein a content of the polyester resin in the binder resin is 50% by mass to 100% by mass.
(22) The toner according to any of (20) or (21), wherein a THF-soluble fraction of the polyester resin has a weight-average molecular weight of 1,000 to 30,000.
(23) The toner according to any one of (20) to (22), wherein the polyester resin has an acid value of 1.0 KOH mg/g to 50.0 KOH mg/g.
(24) The toner according to any one of (20) to (23), wherein the polyester resin has a glass transition temperature of 35° C. to 65° C.
(25) The toner according to any one of (3) to (24), wherein the polymer having a site reactive with a compound having an active hydrogen group has a weight average molecular weight of 3,000 to 20,000.
(26) The toner according to any one of (1) to (25), wherein the toner has an acid value of 0.5 KOH mg/g to 40.0 KOH mg/g.
(27) The toner according to any one of (1) to (26), wherein the toner has a glass transition temperature of 40° C. to 70° C.
(28) The toner according to any one of (1) to (27), wherein the toner is a toner used for a two-component developer.
(29) A method for producing a toner for developing a latent electrostatic image, containing:

dissolving or dispersing at least, a binder resin and/or a precursor of a binder resin, a colorant, a releasing agent, and a modified layered inorganic mineral in which at least a part of ions present in between layers of a layered inorganic mineral is replaced with an organic ion, in an organic solvent so as to prepare an oil phase;

dispersing the oil phase in an aqueous medium so as to prepare an emulsified dispersion; and

removing the solvent from the emulsified dispersion so as to yield toner particles,

wherein the toner particles constitute a toner, the toner contains 1% by mass to 10% by mass of the releasing agent, the releasing agent has an average dispersed particle diameter of 0.1 μm to 0.5 μm; and the toner has a ratio A/B of 0.2 to 2.0, where A denotes an average dispersed particle diameter of the releasing agent and B denotes an average dispersed particle diameter of the modified layered inorganic mineral.
(30) A method for producing a toner for developing a latent electrostatic image, containing:

dissolving or dispersing at least, a binder resin and/or a precursor of a binder resin, a colorant, a releasing agent, and a modified layered inorganic mineral in which at least a part of ions present in between layers of a layered inorganic mineral is replaced with an organic ion, in an organic solvent so as to prepare an oil phase;

dispersing the oil phase in an aqueous medium so as to prepare an emulsified dispersion; and

removing the solvent from the emulsified dispersion so as to yield toner particles,

wherein the toner particles constitute a toner, the releasing agent has an average dispersed particle diameter of 0.1 μm to 0.5 μm, and a proportion of the dispersed particles of the releasing agent having a particle diameter of 1 μm or more in the dispersed particles of the releasing agent having a particle diameter of 0.5 μm or more is 20% by number or less.
(31) A method for producing a toner for developing a latent electrostatic image, containing:

dissolving or dispersing at least a polymer having a site reactive with a compound having an active hydrogen group, a binder resin and/or a precursor of a binder resin, a colorant, a releasing agent, and a kneaded composite of the binder resin and a modified layered inorganic mineral in which at least a part of ions present in between layers of a layered inorganic mineral is replaced with an organic ion, in an organic solvent so as to prepare an oil phase;

dispersing the oil phase in an aqueous medium containing resin fine particles so as to allow the polymer to react; and

removing the solvent after or during the reaction so as to yield the toner particles,

wherein the releasing agent has an average dispersed particle diameter of 0.1 μm to 0.5 μm, and a proportion of the dispersed particles of the releasing agent having a particle diameter of 1 μm or more in the dispersed particles of the releasing agent having a particle diameter of 0.5 μm or more is 20% by number or less.
(32) The method according to any one of (29) to (31), wherein the dispersed particles of the releasing agent having a particle diameter of 0.5 μm or more have an aspect ratio of the particle of 0.800 or less, and the dispersed particles of the releasing agent having a particle diameter of 1 μm or more account for 20% by number or less in the dispersed particles of the releasing agent having a particle diameter of 0.5 μm or more.
(33) An image forming method, containing:

transferring a toner image formed of the toner as in any one of (1) to (28) and carried on a toner image bearing member to a transferring member; and

cleaning the toner remained on the toner image bearing member after the transferring, by using a blade.
(34) An image forming apparatus, containing:

a transferring unit configured to transfer a toner image formed of the toner as in any one of (1) to (28) and carried on a toner image bearing member to a transfer material; and

a cleaning unit configured to clean the toner remained on the toner image bearing member after the transferring, by using a blade.
(35) A process cartridge containing:

a toner image bearing member;

a developing unit; and

at least one unit selected from the group consisting of:
a charging unit; and
a cleaning unit,

wherein the process cartridge integrally disposes the developing unit, and is attachably and detachably disposed in a body of an image forming apparatus, and

wherein the developing unit houses the toner as in any one of (1) to (28).

The toner for developing a latent electrostatic image of the present invention has an excellent low-temperature fixability, gives little residual toner after transfer in an apparatus using blade cleaning, and provides high-quality and high-resolution images.

### BRIEF DESCRIPTION OF THE SEVERAL VIEWS OF THE DRAWINGS

FIG. 1 shows a principal portion sectional constitution diagram of one example of an image forming apparatus; and

FIG. 2 is a conceptual diagram showing a structure of the process cartridge of the present invention.

### DETAILED DESCRIPTION OF THE INVENTION

One feature of the present invention lies in using a layered inorganic mineral modified by replacing at least a part of ions present in between layers thereof with an organic ion, as a raw material of a toner.

It is believed that although the layered inorganic mineral is hydrophobic during the granulation, affinities for a water phase and an oil phase (with respect to an oil phase, affinity changes also depending on the polarity of the oil phase itself) change depending on the kind of ions present in between the layers, the amount of the ions to be replaced and the like.

The present invention enables a localized distribution of a modified layered inorganic mineral in the vicinity of the toner surface by modifying interlayers of a layered inorganic mineral with an organic ion at a level suitable for the modified layered inorganic mineral to be localized in the vicinity of the surface inside toner particles when a toner is granulated as an oil phase in a water system. That is, the modified layered inorganic mineral move to the surface side in oil droplets, and have a characteristic of being easily localized in the toner surface. When the modifying amount of the interlayers with an organic ion is small, since the hydrophobicity of the layered inorganic mineral becomes insufficient and the exfoliation of interlayers of the layered inorganic mineral becomes difficult, the dispersion thereof in a toner becomes difficult, whereby the layered inorganic mineral is not sufficiently observed as an A1 amount in the surface.

When the modifying amount of a layered inorganic mineral with an organic ion is made large, ion species are altered, or the surface treatment is carried out to enhance hydrophobicity, the layered inorganic mineral tends to be homogeneously dispersed in a toner particle or localized in the center of the toner particle.

The chargeability is generally believed to be largely influenced by a charge control agent on the toner surface and in fact, the presence of a large amount of a modified layered inorganic mineral in the surface provides a sufficient chargeability.

Adjustment of the content of the modified layered inorganic mineral allows the viscosity control of an oil phase, and allows to make a toner into a nonspherical shape because the modified layered inorganic mineral is localized in the vicinity of the toner surface. A modified layered inorganic mineral has preferably an average dispersed particle diameter of 0.1 μm to 0.55 μm, more preferably 0.1 μm to 0.5 μm. The volume average particle diameter Dv exceeding 0.55 μm decreases the effect on the toner shape and the toner chargeability.

The modified layered inorganic mineral is contained in a toner material composition (toner) preferably in an amount of 0.05% by mass to 5.0% by mass, more preferably 0.1% by mass to 5.0% by mass. The content of less than 0.05% by mass decreases the effect on the toner shape and the toner chargeability and the content exceeding 5% by mass deteriorates the fixing performance.

However, an increase in the loading amount to acquire the chargeability/nonsphericity exhibits as a side effect a phenomenon that a releasing agent is not homogeneously contained in a toner. When a toner of one type was classified to fabricate toners having different particle diameters and respective contents of a releasing agent in the toners were measured, there was a tendency that the content of the releasing agent on the fine powder side was smaller than that on the coarse powder side and there was a scatter in the releasing agent content depending on the particle diameter. That is, the content of the releasing agent is lower for the toner on the fine powder side and higher for the toner on the coarse powder side. Hence, a toner having a large scatter in the releasing agent content depending on the particle diameter generates degraded fixability/spent, and cannot give a sufficient quality.

As a result of studies, the present inventors have found that control of average dispersed particle diameter of the modified layered inorganic mineral and the releasing agent can improve the problem described above. The average dispersed particle diameter of the releasing agent exceeding 0.5 μm degrades the granulability, and causes a scatter in the releasing agent content depending on the particle diameter; by contrast, that of less than 0.1 μm degrades the releasability of the toner surface and degrades the offset resistance. Thus, the average dispersed particle diameter of the releasing agent must be 0.1 μm to 0.5 μm. Further, where A denotes an average dispersed particle diameter of the releasing agent and B denotes an average dispersed particle diameter of the modified layered inorganic mineral, a larger A/B gives a more poorly homogeneous oil phase, degrades more easily the granulability, and causes a scatter in the releasing agent content depending on the particle diameter. Therefore, a smaller A/B gives a more favorable granulability, and further reduces the scatter in the releasing agent content depending on the particle diameter. In the present invention, A/B must be 0.2 to 2.0.

The average dispersed particle diameters of the releasing agent and the modified layered inorganic mineral mean a volume average particle diameter measured in a state of being dispersed in a dispersion medium such as an organic solvent or a binder resin. For example, when the releasing agent and the modified layered inorganic mineral are added as a kneaded composite (master batch) of a dispersed liquid thereof and a binder resin to an oil phase in the course of producing the toner of the present invention, their volume average particle diameter in the state of being the dispersed liquid or the kneaded composite is measured. More specific measuring methods will be described later.

In the present invention, with respect to a liquid containing toner materials, the toner materials are preferably dissolved or dispersed in a solvent. The solvent preferably contains an organic solvent. The organic solvent is preferably removed when or after base particles of a toner are formed.

An organic solvent is suitably selected according to the purposes, but is preferably that having a boiling point of less than 150° C. because the solvent can easily be removed. The solvent specifically includes toluene, xylene, benzene, carbon tetrachloride, methylene chloride, 1,2-dichloroethane, 1,1,2-trichloroethanetrichloroethylene, chloroform, monochlorobenzene, dichloroethylidene, methyl acetate, ethyl acetate, methyl ethyl ketone and methyl isobutyl ketone. Among them, toluene, xylene, benzene, methylene chloride, 1,2-dichloroethane, chloroform, carbon tetrachloride and the like are preferable and ethyl acetate is especially preferable. These may be used singly or in a combination of two or more.

The using amount of an organic solvent can be suitably selected according to the purposes, but is preferably 40 parts to is 300 parts, more preferably 60 parts to 140 parts, further preferably 80 to 120 parts to 100 parts of toner materials.

Toner materials other than a binder resin, a releasing agent, a colorant and a modified layered inorganic mineral can be suitably selected according to the purposes, but the binder resin may usually contain one of a monomer, a polymer, a compound having an active hydrogen group and a polymer reactive with an active hydrogen group.

A layered inorganic mineral means an inorganic mineral in which layers each having a thickness of several nanometers are laminated; and modifying means to introduce an organic ion as an ion present between layers. Broadly speaking, modifying is called intercalation.

Layered inorganic minerals are known to include smectites (montmorillonite, saponite, etc.), kaolins (kaolinite, etc.), magaduite and kanemite. A layered inorganic mineral has a high hydrophilicity due to its layer structure. Therefore, if a layered inorganic mineral without being modified is dispersed in an aqueous medium and used for a toner to be granulated, the layered inorganic mineral moves to the aqueous medium, so the toner cannot be made into a nonspherical shape; but if the layered inorganic mineral is modified, it easily make a toner into a nonspherical shape on granulation, is dispersed and fined, fully exhibiting a charge adjustment function.

In the toner of the present invention, the ratio (Dv/Dn) of the volume average particle diameter (Dv) to the number average particle diameter (Dn) is preferably 1.00 to 1.30; in this case, a high-resolution and high-image quality toner can be obtained. Further, in a two-component developer, even if the toner of this case is consumed/recovered over a long period, the toner in the developer has a small variation in particle diameter and also even if the developer is agitated over a long period in a developing apparatus, the toner allows a favorable and stable developability. Dv/Dn exceeding 1.30 gives a large scatter in particle diameter of the individual toner particles, and generates a scatter in the toner behavior on development and other processes, damaging reproducibility of minute dots and not providing high-quality images. Further preferably, Dv/Dn is in the range of 1.00 to 1.20, providing more favorable images.

In the toner of the present invention, the volume average particle diameter Dv is preferably 3.0 μm to 7.0 μm. A smaller particle diameter of a toner is generally said to have a more advantage to provide high-resolution and high-quality images, but by contrast, it has a disadvantage for transferability and cleanability. When the volume average particle diameter is smaller than the range described above, in a two-component developer, the toner is fused on the carrier surface in a long-period agitation in a developing apparatus, decreasing the charging capability of the carrier; in use as one-component developer, the toner is liable to generate the filming of the toner on a developing roller and the fusion of the toner on a member such as a blade to make the toner of a thin layer. These phenomena have a strong relation with the content of a fine powder and especially when a toner has toner particles of 2 μm or less exceeding 20% by number, the toner causes trouble for adhesion to a carrier and stabilization of charging at a high level. By contrast, in the case of a toner having a larger particle diameter than the range described above, high-resolution and high-quality images are hardly obtained, and the variation in particle diameter of the toner often becomes large in the consumption/recovery of the toner in a developer. The case of the volume average particle diameter/number average particle diameter of 1.30 or more was also revealed to exhibit the similar results.

Since a toner having a fine and uniform particle diameter has difficulty in cleanability as described before, the shape factor SF-1 of a toner is preferably in the range of 110 to 200; SF-2 is preferably in the range of 110 to 300.

First, the relation of the toner shape and the transferability will be described. In the case using full-color copying machines in which toners are transferred in multicolor development, the toner amount on a photoreceptor increases as compared with monochrome black toners used in monochrome copying machines, and only use of a conventional amorphous toner hardly improves the transfer efficiency. Further, in the case of using a conventional amorphous toner, the fusion and filming of the toner is liable to take place on the surfaces of a photoreceptor and an intermediate transfer body due to a shearing force and a rubbing force between the photoreceptor and a cleaning member, the intermediate transfer body and the cleaning member, and/or the photoreceptor and the intermediate transfer body, which is liable to degrade the transfer efficiency. In generation of full-color images, four-color toner images are hardly uniformly transferred; further, in the case of using an intermediate transfer body, problems in color unevenness and color balance are easily caused and high-quality full-color images are not easily stably output.

From the viewpoint of the blade cleaning and the transfer efficiency, the shape factor SF-1 of a toner is 110 to 200, preferably 120 to 180, thereby simultaneously satisfying both the cleaning and the transferability. The cleaning and the transferability also depend largely on the material quality of a blade and the applying way of the blade, and transferring also depends on process conditions, so designing according to processes can be made in the range of SF-1 described above. However, with SF-1 below 110, cleaning by a blade becomes difficult. With SF-1 exceeding 200, the transferability described above is seen to be degraded. This phenomenon occurs because of a nonspherical shape of the toner, a poor smoothness of movement of the toner on transferring (from a photoreceptor surface to a transfer paper, a photoreceptor surface to an intermediate transfer belt, a first intermediate transfer belt to a second intermediate transfer belt and the like) and further a scatter in behavior among the toner particles, not providing a uniform and high transfer efficiency, and besides, starting to develop the instability of charging and the brittleness of the particles. Further, it causes a finely powdering phenomenon in a developer and causes a decrease in durability of the developer.

In the case of a crushed toner, although the toner has an amorphous form (does not have a specified neat shape and a round shape) and a shape factor SF-1 exceeding 140, since the toner generally has a broad particle diameter distribution, the fabricating process is a poor-efficiency process for making Dv/Dn of 1.30 or less. In the case of obtaining a toner by polymerization, it is difficult to fabricate a toner of a polyester, for example, by suspension polymerization and emulsion polymerization, so the toner cannot be adapted to a further low-temperature fixing. Japanese Patent Application Laid-Open (JP-A) Nos. 11-149180 and 2000-292981 propose a dry-type toner containing a toner binder obtained by subjecting a prepolymer containing an isocyanate group to an extension reaction and/or a crosslinking reaction, and a colorant, of which the dry-type toner contains particles formed by the extension reaction and/or the crosslinking reaction of the prepolymer (A) with amines (B) in an aqueous medium, and propose its manufacturing method, but since the toner shape of the present invention is not obtained, the toner cannot satisfy both the transferability and the cleanability simultaneously.

Then, in the present invention, a method using a reaction of the prepolymer (A) with amines (B) can easily provide a toner whose shape factor SF-1 is 110 to 200 and whose shape factor SF-2 is 10 to 300, by adding a process in which a modified layered inorganic mineral obtained by modification by replacing at least a part of ions present in between layers of a layered inorganic mineral with an organic ion, and a binder resin are kneaded and compounded, and a process of dissolving or dispersing the kneaded composite, to exhibit a suitable dispersion state of the modified layered inorganic mineral in a toner. The suspension polymerization and emulsion polymerization, which are conventionally performed, can hardly control the shape, which is different from the present invention.

Hereinafter, measurement methods with respect to properties of the toner of the present invention will be described.

### (Toner Shape)

The shape factors SF-1 and SF-2, which are circularities used in the present invention, are defined in terms of values obtained by randomly sampling 300 images of SEM images of a toner by measurement by FE-SEM (S-4200), made by Hitachi, Ltd., introducing for analysis the image information to an image analyzer (LuzexAP), made by Nireco Corp., through an interface, and calculating by the expressions below. The values of SF-1 and SF-2 are preferably values determined by the above Luzex, but an imaging apparatus and an image analyzer are not especially limited to the above FE-SEM apparatus and image analyzer as long as similar results can be obtained.

SF-1=(L2/A)×(p/4)×100

SF-2=(P2/A)×(1/4p)×100

(wherein L denotes an absolute maximum length of a toner; A denotes a projected area of a toner; and P denotes a maximum circumferential length of a toner.)

When a toner has a true spherical shape, either of SF-1 and SF-2 is 100, and as the value becomes larger than 100, the shape approaches an amorphous shape from the spherical shape. Particularly, SF-1 is a shape factor representing an entire shape (ellipse, sphere and the like) of a toner and SF-2 is a shape factor representing the degree of unevenness of the surface thereof.

### (Particle Diameter of Toner)

The average particle diameter and the particle diameter distribution are measured by the Coulter Counter method. Measuring instruments of particle diameter distribution of toner particles include Coulter Counter TA-II and Coulter Multisizer II (made by Beckman Coulter Co., Ltd.). In the present invention, they were measured by using Coulter Counter TA-II and connecting to an interface (The Institute of JUSE) and a personal computer PC9801 (made by NEC Corp.) that output the number distribution and the volume distribution.

The measurement methods will be described hereinafter.

First, 0.1 ml to 5 ml of a surfactant as a dispersant (preferably alkylbenzenesulfonate) is added to 100 ml to 150 ml of an electrolytic aqueous solution. The electrolytic solution is a prepared about-1% NaCl aqueous solution using a first grade sodium chloride and for example, ISOTON-II (made by Beckman Coulter Co., Ltd.) is usable. 2 mg to 20 mg of a measurement sample is further added thereto. The electrolytic solution containing the suspended sample was subjected to a dispersion treatment for about 1 min to 3 min by an ultrasonic disperser; and the volume and the number of toner particles are measured by the above-mentioned analyzer using an aperture of 100 μm as an aperture to calculate the volume distribution and the number distribution.

Used channels are 13 channels of 2.00 μm to less than 2.52 μm, 2.52 μm to less than 3.17 μm, 3.17 μm to less than 4.00 μm, 4.00 μm to less than 5.04 μm, 5.04 μm to less than 6.35 μm, 6.35 μm to less than 8.00 μm, 8.00 μm to less than 10.08 μm, 10.08 μm to less than 12.70 μm, 12.70 μm to less than 16.00 μm, 16.00 μm to less than 20.20 μm, 20.20 μm to less than 25.40 μm, 25.40 μm to less than 32.00 μm and 32.00 μm to less than 40.30 μm, and particles having a particle diameter of 2.00 μm or more and less than 40.30 μm are measured as an object.

The volume average particle diameter (Dv) from a volume distribution, the number average particle diameter (Dn) from a number distribution, and the ratio thereof Dv/Dn, which are relevant to the present invention, are determined.

### (Circularity)

The toner of the present invention essentially has a specified shape, and an amorphous toner having an average circularity of 0.93 or less, too far away from the sphere, cannot provide a satisfactory transferability and high-quality images with no dusts. A suitable measurement method of the shape is a technique using an optical detection zone which involves passing a suspension containing particles through an image picking-up detection zone on a flat plate, optically detecting particle images by a CCD camera, and analyzing the detected images. A toner which has an average circularity of 0.93 to 0.97 which is a value obtained by dividing the circumferential length of a corresponding circle having a projected area equal to that obtained by the technique by the circumferential length of a real particle, is effective for forming high-definition images having a suitable density and the reproducibility. With the average circularity exceeding 0.97, systems employing blade cleaning and the like cause cleaning faults of a photoreceptor, transfer belt and the like, and cause stains on images.

Further, particles having a circularity of 0.950 or less preferably account for 20% to 80% of the entire toner particles. From the view point of the balance of the blade cleaning and the transferability, that particles having a circularity of 0.950 or less account for 20% to 80% of the entire toner particles, satisfies both the cleaning and the transferability simultaneously. The cleaning and the transferability depend largely on the material of a blade and the applying way of the blade, and further, the transferring also depends on process conditions, so the designing according to processes is possible in the above-mentioned range. However, if particles having a circularity of 0.950 or less account for less than 20% of the entire toner particles, the cleaning by a blade becomes difficult. If particles having a circularity of 0.950 or less account for more than 80% of the entire toner particles, the above-mentioned transferability is observed to worsen. This phenomenon is because the toner shape is excessively nonspherical, the movement of the toner on transferring (a photoreceptor surface to a transfer paper, a photoreceptor surface to an intermediate transfer belt, a first transfer belt to a second transfer belt, and the like) becomes less smooth and further the behavior among the toner particles causes scatter, not providing a uniform and high transfer efficiency. Besides, the instability of charging and the brittleness of particles begin to develop. Further, causing the micropulverization phenomenon in a developer becomes a factor decreasing the durability of the developer. Therefore, particles having a circularity of a toner of 0.950 or less preferably account for 20% to 80% of the entire toner particles.

### (Particle Diameter of 2 μm or Less and its Circularity)

The particle content and the circularity of particles having a particle diameter of 2 μm or less of the toner of the present invention can be measured by a flow-type particle image analyzer FPIA-2000 (made by Sysmex Corp.). The specific measurement method involves adding a surfactant as a dispersant, preferably 0.1 ml to 0.5 ml of alkylbenzenesulfonate, in 100 ml to 150 ml of water in a vessel from which impurity solids have been previously removed, and further adding 0.1 g to 0.5 g of a measurement sample. The suspension in which the sample is dispersed is subjected to a dispersion treatment by an ultrasonic disperser for about 1 min to 3 min, and the shape and the distribution of the toner are measured with the dispersion concentration of 3,000 to 10,000 particles/μl by the above analyzer.

According to further studies of the present invention, for holding the thermal resistant preservability, exhibiting effectively the lower-temperature fixability and imparting the offset resistance after modification with a prepolymer, use of a polyester resin as a binder resin is preferable and the polyester resin preferably has a weight-average molecular weight of a THF-soluble fraction of 1,000 to 30,000. This is because with the molecular weight of less than 1,000, since an oligomer component increases, the thermal resistant preservability worsens; and with the molecular weight exceeding 30,000, since the modification with the prepolymer becomes insufficient due to steric hindrance, the offset resistance worsens.

The above-mentioned weight-average molecular weight is measured by GPC (gel permeation chromatography) as follows. A column is stabilized in a heat chamber of 40° C.; THF as a solvent is made to flow through the column of the temperature at a flow rate of 1 ml/min; and 50 μl to 200 μl of a THF sample solution of a resin prepared such that the sample concentration is 0.05% by mass to 0.6% by mass is injected to the column for measurement. In the measurement of the sample molecular weight, the molecular weight distribution is calculated from the relation between logarithmic values and count numbers of a calibration curve made with several kinds of monodispersion polystyrene standard samples. Standard polystyrene samples to be used for making the calibration curve are those, made by, for example, Pressure Chemical Co. or Tosoh Corp., whose molecular weights are 6×10², 2.1×10³, 4×10³, 1.75×10⁴, 5.1×10⁴, 1.1×10⁵, 3.9×10⁵, 8.6×10⁵, 2×10⁶ and 4.48×10⁶. Use of at least 10 samples of the standard polystyrene samples is suitable. A detector to be used is an RI (refraction index) detector.

Making the acid value of the polyester resin to be 1.0 to 50.0 (KOH mg/g) allows making toner characteristics, such as particle-diameter control, low-temperature fixability, high-temperature offset resistance, heat resistant preservability, charge stability and the like by addition of a basic compound, to be of a higher quality. That is, this is because the acid value exceeding 50.0 (KOH mg/g) makes the extension or crosslinking reaction of a modified polyester to be insufficient and exhibits an influence on the high-temperature offset resistance; and that of less than 1.0 (KOH mg/g) cannot provide a dispersion stabilizing effect by a basic compound during manufacture, easily progresses the extension or crosslinking reaction of the modified polyester and causes a problem with the manufacturing stability.

The measuring method of the acid value of the polyester resin of the present invention is according to JIS K0070. Here, in the case of a sample which does not dissolve, dioxane, THF or the like is used as a solvent.

The acid value is determined specifically by the following procedure.

Measurement instrument: automatic potentiometric titrator DL-53 Titrator (made by Mettler-Toledo International Inc.);

Using electrode: DG113-SC (made by Mettler-Toledo International Inc.);

Analysis software: LabX Light Version 1.00.000;

Calibration of the instrument: Using a mixed solvent of 120 ml of toluene and 30 ml of ethanol; and

Measurement temperature: 23° C.

Measurement conditions are as follows.

Stir

| | |
|---|---|
| Speed [%] | 25 |
| Time [s] | 15 |

EQP titration
Titrant/Sensor

| | |
|---|---|
| Titrant | CH₃ONa |
| Concentration [mol/L] | 0.1 |
| Sensor | DG115 |
| Unit of measurement | mV |

Predispensing to volume

| | |
|---|---|
| Volume [mL] | 1.0 |
| Wait time [s] | 0 |

| Titrant addition | Dynamic |
|---|---|
| dE(set) [mV] | 8.0 |
| dV(min) [mL] | 0.03 |
| dV(max) [mL] | 0.5 |

| Measure mode | Equilibrium controlled |
|---|---|
| dE [mV] | 0.5 |
| dt [s] | 1.0 |
| t(min) [s] | 2.0 |
| t(max) [s] | 20.0 |

Recognition

| | |
|---|---|
| Threshold | 100.0 |
| Steepest jump only | No |
| Range | No |
| Tendency | None |

Termination

| | |
|---|---|
| at maximum volume [mL] | 10.0 |
| at potential | No |
| at slope | No |
| after number EQPs | Yes |
| n = 1 | |
| comb. termination conditions | No |

Evaluation

| | |
|---|---|
| Procedure | Standard |
| Potential 1 | No |
| Potential 2 | No |
| Stop for reevaluation | No |

### (Measuring Method of the Acid Value)

The acid value is measured under the following conditions according to the measuring method described in JIS K0070-1992. Sample preparation: 0.5 g of a polyester (0.3 g of its ethyl acetate-soluble fraction) is added to 120 ml of toluene, and stirred at room temperature (23° C.) for about 10 hours for dissolution. 30 ml of ethanol is further added to make a sample solution.

The acid value can be calculated by the instrument described above, but is specifically calculated as follows. The sample solution is titrated with a previously standardized N/10-potassium hydroxide alcohol solution and an acid value is determined from the consumption amount of the alcoholic potassium hydroxide solution by the following calculation.

Acid value=KOH (ml)×N×56.1/weight of a sample

(wherein N denotes a factor of the N/10 KOH)

In the present invention, since the heat resistant preservability of main components of a polyester resin after being modified, i.e., a binder resin, depends on the glass transition temperature of the polyester resin before being modified, a is polyester resin is preferably designed to have a glass transition temperature of 35° C. to 65° C. That is, with the glass transition temperature of less than 35° C., the heat resistant preservability is insufficient; and with that exceeding 65° C., it adversely affects the low-temperature fixability.

The measurement method of the glass transition temperature in the present invention will be described in the paragraph of Examples.

According to further studies of the present invention, a polymer having a site reactive with a compound having an active hydrogen group is an important binder resin component to achieve the low-temperature fixability and high-temperature offset resistance, and the weight-average molecular weight thereof is preferably 3,000 to 20,000. That is, with the weight-average molecular weight of less than 3,000, the reaction rate becomes difficult to control and the manufacturing stability begins to cause a problem; and with that exceeding 20,000, a sufficiently modified polyester cannot be obtained and the polymer begins to exercise an effect on the offset resistance.

Further studies of the present invention has revealed that the toner acid value is a more important index for the low-temperature fixability and high-temperature offset resistance than the acid value of a binder resin. The toner acid value of the present invention is originated from a terminal carboxyl group of an unmodified polyester. The unmodified polyester preferably has an acid value of 0.5 to 40.0 (KOH mg/g) for controlling the low-temperature fixability (fixing lower limit temperature, hot offset generating temperature and the like) as a toner. That is, this is because with the acid value exceeding 40.0 (KOH mg/g), the extension or crosslinking reaction of a modified polyester becomes insufficient and an effect on the high-temperature offset resistance is observed; and with that of less than 0.5 (KOH mg/g), the dispersion stabilizing effect by a basic compound in manufacturing cannot be obtained and the extension or crosslinking reaction of the modified polyester easily progresses, causing a problem with the manufacturing stability.

The acid value is measured by the method according to JIS K0070. Here, in the case of a sample which does not dissolve, dioxane, THF or the like is used as a solvent.

The acid value of a toner can be measured and determined by the same measurement instrument and measurement conditions as those described in the above-mentioned measurement method of the acid value of the polyester resin.

### (Measurement Method of the Acid Value)

The acid value is measured under the following conditions according to the measurement method described in JIS K0070-1992. Sample preparation: 0.5 g of a toner (0.3 g of its ethyl acetate-soluble fraction) is added to 120 ml of toluene, and stirred at room temperature (23° C.) for about 10 hours for dissolution. 30 ml of ethanol is further added to make a sample solution.

The acid value can be calculated by the instrument described above, but is specifically calculated as follows. The sample solution is titrated with a previously standardized N/10-potassium hydroxide alcohol solution and an acid value is determined from the consumption amount of the alcoholic potassium hydroxide solution by the following calculation.

Acid value=KOH (ml)×N×56.1/weight of a sample

(wherein N denotes a factor of the N/10 KOH)

The toner of the present invention preferably has a glass transition temperature of 40° C. to 70° C. for providing the low-temperature fixability, heat resistant preservability and high durability. That is, with the glass transition temperature of less than 40° C., the blocking in a developing machine and the filming on a photoreceptor are liable to generate; and with that exceeding 70° C., the low-temperature fixability is liable to worsen.

The toner of the present invention is obtained, at least, by dispersing an oil phase containing a toner composition and/or a toner composition precursor in an aqueous medium and granulating, or at least, by dissolving or dispersing in an organic solvent a polymer having a site reactive with a compound having an active hydrogen group, a binder resin, a colorant, a releasing agent and a kneaded composite of the binder resin and a modified layered inorganic mineral obtained by modification by replacing at least a part of ions present in between layers of a layered inorganic mineral with an organic ion, dispersing the solution or dispersion in an aqueous medium containing resin fine particles, and after or during reacting the polymer having a site reactive with the compound having an active hydrogen group, removing the organic solvent, and washing and drying the resultant.

A polymer, used in the present invention, having a site reactive with a compound having an active hydrogen group includes a reactive modified polyester resin (RMPE) reactive with active hydrogen, for example, a polyester prepolymer (A) having an isocyanate group. The prepolymer (A) includes a prepolymer obtained by reacting further with a polyisocyanate (PIC) a polyester which is a polycondensate of a polyol (PO) and a polycarboxylic acid (PC) and has active hydrogen. A group containing active hydrogen the polyester has includes a hydroxyl group (alcoholic hydrogen group and phenolic hydrogen group), an amino group, a carboxyl group and a mercapto group, and among these preferable is an alcoholic hydrogen group. As a crosslinking agent for the reactive modified polyester resin, amines are used, and as an extension agent, diisocyanate compounds (diphenylmethane diisocyanate and the like) are used. Amines later described in detail act as a crosslinking agent and an extension agent for a modified polyester reactive with active hydrogen.

With respect to a modified polyester such as a urea-modified polyester obtained by reacting the polyester prepolymer (A) having the isocyanate group with amines (B), the molecular weight of its polymer component can easily be controlled, so the modified polyester is advantageous especially for securing the oilless low-temperature fixability (broad releasability and fixability having no mechanism to apply a releasing oil to a heating medium for fixing). Particularly, a polyester prepolymer whose terminal has been urea-modified has a suppressed adhesiveness to a heating medium for fixing while it holds a high fluidity and transparency in the fixing temperature range of the unmodified polyester resin itself.

A preferable polyester prepolymer used in the present invention is a polyester prepolymer obtained by incorporating a polyester having an active hydrogen such as an acid group or a hydroxyl group on its terminal with a functional group such as an isocyanate group, which reacts with the active hydrogen. A modified polyester (MPE) such as a urea-modified polyester can be derived from the prepolymer, but in the present invention, a modified polyester favorably used as a toner binder is a urea-modified polyester obtained by reacting a polyester prepolymer (A) having an isocyanate group with amines (B) as crosslinking agents and/or extension agents. The polyester prepolymer (A) having an isocyanate group can be obtained by reacting further with a polyisocyanate (PIC) a polyester which is a polycondensate of a polyol (PO) and a polycarboxylic acid (PC) and has an active hydrogen group. The active hydrogen group the polyester has includes a hydroxyl group (alcoholic hydroxyl group and phenolic hydroxyl group), an amino group, a carboxyl group and a mercapto group, and among these preferable is an alcoholic hydroxyl group.

Polyols (PO) include diols (DIO) and tri- or more valent polyols (TO), and a diol (DIO) singly or a mixture of a diol (DIO) and a small amount of a polyol (TO) is preferable. Diols (DIO) include alkylene glycols (ethylene glycol, 1,2-propylene glycol, 1,3-propylene glycol, 1,4-butanediol, 1,6-hexanediol, etc.); alkylene ether glycols (diethylene glycol, triethylene glycol, dipropylene glycol, polyethylene glycol, polypropylene glycol, polytetramethylene ether glycol, etc.); alicyclic diols (1,4-cyclohexane dimethanol, hydrogenated bisphenol A, etc.); bisphenols (bisphenol A, bisphenol F, bisphenol S, etc.); alkylene oxide (ethylene oxide, propylene oxide, butylene oxide, etc.) adducts of the above-mentioned alicyclic diols; and alkylene oxide (ethylene oxide, propylene oxide, butylene oxide, etc.) adducts of the above-mentioned bisphenols.

Among these preferable are alkylene glycols having 2 to 12 carbon atoms and alkylene oxide adducts of bisphenols, and especially preferable is a concurrent use of an alkylene oxide adduct of a bisphenol and an alkylene glycol having 2 to 12 carbon atoms. Tri-or more valent polyols include tri-to octa-or more polyhydric fatty alcohols (glycerol, trimethylolethane, trimethylolpropane, pentaerythritol, sorbitol, etc.); tri-or more valent phenols (trisphenol PA, phenol novolak, cresol novolak, etc.); and alkylene oxide adducts of the above-mentioned tri-or more valent polyphenols.

Polycarboxylic acids (PC) include dicarboxylic acids (DIC) and tri- or more valent polycarboxylic acids (TC), and a DIC singly or a mixture of a DIC and a small amount of a polycarboxylic acid (TC) is preferable. Dicarboxylic acids (DIC) include alkylene dicarboxylic acids (succinic acid, adipic acid, sebacic acid, etc.); alkenylene dicarboxylic acids (maleic acid, fumaric acid, etc.); and aromatic dicarboxylic acids (phthalic acid, isophthalic acid, terephthalic acid, naphthalenedicarboxylic acid, etc.). Among these preferable are an alkenylene dicarboxylic acid having 4 to 20 carbon atoms and an aromatic dicarboxylic acid having 8 to 20 carbon atoms. Tri- or more valent polycarboxylic acids (TC) include aromatic polycarboxylic acids having 9 to 20 carbon atoms(trimellitic acid, pyromellitic acid, etc.). Polycarboxylic acids (PC) may be obtained by reacting an acid anhydride of the above-mentioned polycarboxylic acid or a lower alkyl ester (methyl ester, ethyl ester, isopropyl ester, etc.) with a polyol (PO). The ratio of a polyol (PO) to a polycarboxylic acid (PC) in terms of the equivalent ratio (OH)/(COOH) of hydroxyl group (OH) to carboxyl group (COOH), is commonly 2/1 to 1/1, preferably 1.5/1 to 1/1, further preferably 1.3/1 to 1.02/1.

Polyisocyanates (PIC) include aliphatic polyisocyanates (tetramethylene diisocyanate, hexamethylene diisocyanate, 2,6-diisocyanatomethyl caproate, etc.); alicyclic polyisocyanates (isophorone diisocyanate, cyclohexylmethane diisocyanate, etc.); aromatic diisocyanates (tolylene diisocyanate, diphenylmethane diisocyanate, etc.); araliphatic diisocyanates (α,α,α′,α′-tetramethylxylylene diisocyanate, etc.); isocyanurates; polyisocyanates obtained by blocking the above-mentioned polyisocyanates with a phenol derivative, an oxime, caprolactam or the like;, and a concurrent use of these two or more.

The ratio of a polyisocyanate (PIC) in terms of the equivalent ratio (NCO)/(OH) of isocyanate group (NCO) to hydroxyl group (OH) of a polyester having a hydroxyl group, is commonly 5/1 to 1/1, preferably 4/1 to 1.2/1, further preferably 2.5/1 to 1.5/1. With (NCO)/(OH) exceeding 5, the low-temperature fixability deteriorates. With (NCO) of less than 1 in molecular ratio, in the case of using a modified polyester, the urea content in the ester decreases and the hot offset resistance deteriorates. The content of a component constituting a polyisocyanate (PIC) in a prepolymer (A) having an isocyanate group at its terminals is commonly 0.5% by mass to 40% by mass, preferably 1% by mass to 30% by mass, further preferably 2% by mass to 20% by mass. With the content of less than 0.5% by mass, the hot offset resistance deteriorates and there also arises a disadvantage in the simultaneous satisfaction of both the heat resistant preservability and the low-temperature fixability. By contrast, with that exceeding 40% by mass, the low-temperature fixability deteriorates.

The number of isocyanate groups contained in one molecule of a prepolymer (A) having isocyanate groups is commonly 1 or more, preferably 1.5 to 3, further preferably 1.8 to 2.5 in average. With the number of less than 1, the molecular weight of a urea-modified polyester decreases and the hot offset resistance deteriorates.

Amines (B) include diamines (B1), tri- or more valent polyamines (B2), aminoalcohols (B3), aminomercaptans (B4), amino acids (B5) and amines (B6) obtained by blocking the amino groups of B1 to B5. Diamines (B1) include aromatic diamines (phenylenediamine, diethyltoluenediamine, 4,4′-diaminodiphenylmethane, etc.); alicyclic diamines (4,4′-diamino-3,3′-dimethyldicyclohexylmethane, diaminecyclohexane, isophoronediamine, etc.); and aliphatic diamines (ethylenediamine, tetramethylenediamine, hexamethylenediamine, etc.). Tri- or more valent polyamines (B2) include diethylenetriamine and triethylenetetramine. Aminoalcohols (B3) include ethanolamine and hydroxyethylaniline. Aminomercaptans (B4) include aminoethylmercaptan and aminopropylmercaptan. Amino acids (B5) include aminopropionic acid and aminocaproic acid. Amines (B6) obtained by blocking the amino groups of B1 to B5 include ketimine compounds obtained from the amines of B1 to B5 and ketones (acetone, methyl ethyl ketone, methyl isobutyl ketone, etc.), and oxazolidine compounds. Among these amines (B) preferable is a B1 and a mixture of a B1 and a small amount of a B2.

Further as required, the molecular weight of a polyester can be controlled using an extension terminator. Extension terminators include monoamines (diethylamine, dibutylamine, butylamine, laurylamine, etc.) and monoamines (ketimine compounds) obtained by blocking them.

The ratio of amines (B) in terms of the equivalent ratio (NCO)/(NHx) of the isocyanate group (NCO) in a prepolymer (A) having isocyanate groups to the amino group (NHx) in the amines (B), is commonly 1/2 to 2/1, preferably 1.5/1 to 1/1.5, further preferably 1.2/1 to 1/1.2. With (NCO)/(NHx) of more than 2 and of less than 1/2, the molecular weight of a polyester decreases and the hot offset resistance deteriorates.

The polyester resin (polyester) favorably used as a binder resin in the present invention is a urea-modified polyester (UMPE), but the polyester may contain a urethane bond with a urea bond. The molar ratio of the contents of urea bond to urethane bond is commonly 100/0 to 10/90, preferably 80/20 to 20/80, further preferably 60/40 to 30/70. With the molar ratio of urea bond of less than 10%, the hot offset resistance deteriorates.

Modified polyesters such as urea-modified polyesters is (UMPE) are manufactured by the one-shot method and the like. Modified polyesters such as urea-modified polyesters (UMPE) commonly have a weight-average molecular weight of more than 10,000, preferably 20,000 to 10,000,000, further preferably 30,000 to 1,000,000. With the molecular weight of less than 10,000, the hot offset resistance deteriorates. The number-average molecular weight of modified polyesters such as urea-modified polyesters in the case of using an unmodified polyester (PE) described later, is not especially limited and may be such a number-average molecular weight that the above weight-average molecular weight is easily obtained. The number-average molecular weight in the case of using singly a modified polyester such as UMPE is commonly 2,000 to 15,000, preferably 2,000 to 10,000, further preferably 2,000 to 8,000. With the molecular weight exceeding 20,000, the low-temperature fixability, and the glossiness in the case of use in full-color machines deteriorate.

In the present invention, a modified polyester such as an above-mentioned polyester modified with a urea bond may be used not only singly, but may be contained concurrently with an unmodified polyester (PE) as a binder resin component. The concurrent use of PE improves the low-temperature fixability, and the glossiness in the case of use in full-color machines, and is more preferable than the single use. PE includes polycondensates of a polyol PO and a polycarboxylic acid similar to the polyester components of the above-mentioned UMPE, and preferable ones are similar to the case of UMPE. PE has a weight-average molecular weight (Mw) of 10,000 to 300,000, preferably 14,000 to 200,000. The number-average molecular weight (Mn) is 1,000 to 10,000, preferably 1,500 to 6,000. UMPE can be used concurrently not only with an unmodified polyester, but also with a polyester modified with a chemical bond other than urea bond, for example, a polyester modified with a urethane bond. That UMPE and PE are miscible at least partially with each other is preferable in view of the low-temperature fixability and the hot offset resistance. Therefore, the polyester component of UMPE and the PE preferably have analogous compositions. The weight ratio of UMPE and PE in the case of containing PE is commonly 5/95 to 80/20, preferably 5/95 to 30/70, further preferably 5/95 to 25/75, especially preferably 7/93 to 20/80. With the weight ratio of UMPE of less than 5%, the hot offset resistance deteriorates and there also arises a disadvantage in the simultaneous satisfaction of both the heat resistant preservability and the low-temperature fixability.

PE preferably has a hydroxyl value (mg KOH/g) of 5 or more, and commonly has an acid value (mg KOH/g) of 1 to 30, preferably 5 to 20. Having an acid value easily exhibits the negative chargeability, and further has a favorable affinity of paper and a toner in fixing on paper and improves the low-temperature fixability. However, with the acid vale exceeding 30, the stability of charging is likely to deteriorate especially in environmental variations. In the polymerization reaction, fluctuation of the acid value leads to fluctuation in the granulation process and makes the control in emulsification difficult.

The hydroxyl value and acid value of PE can be measured and determined using a similar measurement instrument, electrodes, analysis soft, calibration conditions, measurement temperature and measurement conditions described in the above-mentioned measurement method of the acid value of the polyester resin.

### (Measurement Method of the Acid Value)

An acid value is measured under the following conditions according to the measurement method described in JIS K0070-1992. Sample preparation: 0.5 g of a polyester (0.3 g of its ethyl acetate-soluble fraction) is added to 120 ml of toluene and stirred at room temperature (23° C.) for about 10 hours for dissolution. 30 ml of ethanol is further added to the solution to make a sample solution.

The acid value can be calculated by the above-mentioned instrument, but is specifically calculated as follows.

The sample solution is titrated with a previously standardized N/10-potassium hydroxide alcohol solution and an acid value is determined from the consumption amount of the alcoholic potassium hydroxide solution by the following calculation.

Acid value=KOH (ml)×N×56.1/weight of a sample

(wherein N denotes a factor of the N/10 KOH)

### (Measurement Method of Hydroxyl Value)

0.5 g of a sample is precisely weighed in a measuring flask of 100 ml, and 5 ml of an acetylation reagent is exactly added to the flask. Thereafter, the flask is immersed and heated in a vessel of 100° C.±5° C. 1 to 2 hours later, the flask is taken out from the vessel, allowed to cool, added with water and shaken to decompose acetic acid anhydride. For further completing the decomposition, the flask is again heated in a vessel for 10 min or more, allowed to cool, and the wall of the flask is sufficiently washed with an organic solvent. The resultant liquid is potentiometrically titrated using the above-mentioned electrodes with a N/2-potassium hydroxide ethyl alcohol solution to determine the OH value (according to JIS K0070-1966).

In the present invention, a binder resin commonly has a glass transition temperature (Tg) of 40° C. to 70° C., preferably 40° C. to 60° C. With the temperature of less than 40° C., the toner resistance deteriorates; with that exceeding 70° C., the low-temperature fixability becomes insufficient. The coexistence of a modified polyester such as a urea-modified polyester resin in the dry-type toner of the present invention has a favorable tendency in the heat resistant preservability even with a low glass transition temperature, as compared with well-known polyesters-based toners.

### (Modified Layered Inorganic Mineral)

A modified layered inorganic mineral used for the toner of the present invention is not especially limited, but is preferably one obtained by modifying a layered inorganic mineral having a basic crystal structure of smectite with an organic cation. In the case of a layered inorganic mineral of hydrotalcites, by replacing part of its bivalent metal with a trivalent metal, the ionic balance can be made one which can introduce an anion. By introducing an organic anion into a layered inorganic mineral in this state, the layered inorganic compound modified with the organic anion may be used.

By modifying at least part of a layered inorganic mineral with an organic ion, the layered inorganic mineral has a suitable hydrophobicity; an oil phase containing a toner composition and/or a toner composition precursor has a non-Newtonian viscosity; and the toner can have a nonspherical shape.

Layered inorganic minerals modified with an organic cation include montmorillonite or bentonite, beidellite, nontronite, saponite, hectorite, attapulgite, sepiolite and a mixture thereof. Among these preferable is an organic-modified montmorillonite or bentonite because the viscosity can easily be controlled and a small loading amount thereof can be adopted without influencing toner characteristics.

Organic cation modifying agents for the modified layered inorganic minerals include quaternary alkylammonium salts, phosphonium salts and imidazolium salts, but quaternary alkylammonium salts are desirable. The quaternary alkylammoniums include trimethylstearylammonium, dimethylstearylbenzylammonium, dimethyloctadecylammonium and oleylbis(2-hydroxyethyl)methylammonium.

The modified layered inorganic minerals include BENTONE34, BENTONE52, BENTONE38, BENTONE27, BENTONE57, BENTONE SD1, BENTONE SD2 and BENTONE SD3, made by ELEMENTIS Co., Ltd.; CRAYTONE34, CRAYTONE40, CRAYTONE HT, CRAYTONE2000, CRAYTONE AF, CRAYTONE APA and CRAYTONE HY, made by SCP Co., Ltd.; S-BEN, S-BEN E, S-BEN C, S-BEN NZ, S-BEN NZ70, S-BEN W, S-BEN N400, S-BEN NX, S-BEN NX80, S-BEN N012S, S-BEN NEZ, S-BEN N012, S-BEN WX and S-BEN NE, made by HOJUN Co., Ltd.; and KUNIBIS 110, KUNIBIS 120 AND KUNIBIS 127, MADE BY Kunimine Industries Co., Ltd.

A kneaded composite of the modified layered inorganic mineral and a binder resin, i.e. a master batch, can be obtained by mixing and kneading the binder resin and the modified layered inorganic mineral with a high shearing force applied. At this time, for enhancing the interaction of the modified layered inorganic mineral and the binder resin, an organic solvent can be used. The so-called flushing method in which an aqueous paste containing the modified layered inorganic mineral and water is mixed and kneaded with a resin and an organic solvent and then, the modified layered inorganic mineral is made to move to the resin side to remove the moisture and the organic solvent component, is favorably used because of no need for drying since the wet cake can be used as it is. For mixing and kneading, a high-shearing dispersion apparatus such as a three-roller mill is favorably used.

In a kneaded composite of the modified layered inorganic mineral and a binder resin, i.e. in a master batch, the modified layered inorganic mineral desirably has an average dispersion particle diameter of 0.1 μm to 0.55 μm and the frequency of the modified layered inorganic mineral having a volume average particle diameter of 1 μm or more desirably satisfies 15% or less. If the average dispersion particle diameter exceeds 0.55 μm, or if the frequency of more than 1 μm in particle diameter exceeds 15%, effects on the toner shape and toner chargeability are likely to decrease.

The modified layered inorganic mineral is preferably contained in an amount of 0.05% by mass to 5% by mass in a toner, more preferably 0.1% by mass to 5% by mass. With the content of less than 0.05% by mass, effects on the toner shape and toner chargeability decrease; with that exceeding 5% by mass, the fixability deteriorates.

### (Releasing Agent (Wax))

As a wax used for the toner of the present invention, a wax having a low melting point of 50° C. to 120° C. functions as a releasing agent more in a dispersion with a binder resin effectively between a fixing roller and a toner interface, thereby exhibiting an effect on the high-temperature offset resistance without applying a releasing agent like an oil on the fixing roller.

Here, the melting point of a wax in the present invention is denoted by a maximum endothermic peak by a differential scanning calorimeter (DSC). As wax components functioning as a releasing agent usable in the present invention, the following materials can be used. That is, waxes specifically include vegetable waxes such as carnauba wax, cotton wax, Japan wax and rice wax, animal waxes such as beeswax and lanolin, mineral waxes such as ozokerite and selsyn, and petroleum waxes such as paraffin, microcrystalline and petrolatum. Other than these natural waxes, waxes include synthetic hydrocarbon waxes such as Fischer Tropsch wax and polyethylene wax, synthetic waxes such as esters, ketones and ethers, and the like. Further also usable are fatty acid amides such as 12-hydroxystearic acid amide, stearic acid amide, anhydrous phthalic acid imide and chlorinated hydrocarbons, and crystalline polymers having a long alkyl group as side chains, such as homopolymers or copolymers of polyacrylates, which are low-molecular weight crystalline polymer resins, such as poly-n-stearyl methacrylates and poly-n-lauryl methacrylates (for example, a copolymer of n-stearyl acrylate-ethyl methacrylate), and the like.

A releasing agent is previously dispersed in an organic solvent with the average dispersion particle diameter of 0.1 μm to 0.5 μm and is desirably added to an oil phase in the state of the dispersion. With the average dispersion particle diameter exceeding 0.5 μm, the granulability worsens; by contrast, with that of less than 0.1 μm, the releasing agent amount of the toner surface decreases and the offset resistance deteriorates. The proportion of particles having a particle diameter of 1 μm or more in particles having a particle diameter of 0.5 μm or more in the releasing agent dispersion must be 20% by number or less. With the proportion exceeding 20% by number, the granulability worsens and a uniform particle diameter cannot be obtained.

For dispersing a releasing agent in an organic solvent, an apparatus like a bead mill capable of applying a high shear to a dispersion system is preferably used.

When a releasing agent is dispersed in an organic solvent, a suitable dispersant may be used.

### (Measurement of the Average Dispersion Particle Diameter of a Releasing Agent)

The average dispersion particle diameter of a releasing agent is measured using “LA-920” (made by Horiba Ltd.). At the measurement by LA-920, analysis is performed using a LA-920-dedicated application (Ver 3.32) (made by Horiba Ltd.). The measurement by LA-920 specifically involves measuring the background with a solvent (ethyl acetate) used for a releasing agent dispersion, adjusting the optical axis, then adding dropwise the releasing agent dispersion, and measuring the average dispersion particle diameter under the condition of the transmittance of LA-920 in the range of 70% to 95%. It is important that the average dispersion particle diameter should be measured under the condition of the transmittance of LA-920 in the range of 70% to 95% from the view point of the measurement reproducibility of the particle diameter by this measurement instrument. For obtaining that transmittance, the dropping amount of the dispersion must be adjusted.

The measurement and analysis conditions are set as follows.

The number of data taking-in: 15 times

Relative refractive index: 1.20

Circulation: 5

Ultrasonic intensity: 7

Ultrasonic exposure time: 3 min

### (Measurement of the Content of Particles Having a Particle Diameter of 1 μm or More in a Releasing Agent Dispersion)

The content of particles having a particle diameter of 1 μm or more in particles having a particle diameter of 0.5 μm or more in a releasing agent dispersion is measured using a flow-type particle image analyzer (“FPIA-3000S”; made by Sysmex Corp.), and analyzed using an analysis software (FPIA-3000 Version 00-10). Specifically, 30 g of ethyl acetate is weighed in a beaker of 100 ml; 0.1 g to 1.0 g of a releasing agent dispersion is added thereto and mixed by a micro spatula; and the resultant dispersion is subjected to a dispersion treatment for 1 min by an ultrasonic disperser (Honda Electronics Co., Ltd.). By making an obtained concentration of the resultant dispersion to be 5,000 to 15,000 particles/μl using the FPIA-3000S, the content of particles of 1 μm or more in particles of 0.5 μm or more in the releasing agent dispersion is measured. In this measurement method, it is important that the concentration of the dispersion should be 5,000 to 15,000 particles/μl from the view point of the measurement reproducibility. For obtaining the dispersion concentration, the condition of the dispersion, i.e. the loading amount of a releasing agent dispersion must be altered. The loading amount of a releasing agent dispersion must be small in the case of a small particle diameter, and large in the case of a large particle diameter.

The content of particles having a particle diameter of 1 μm or more in particles having a particle diameter of 0.5 μm or more and an aspect ratio of 0.800 or less in a releasing agent dispersion is also measured as in the measurement of the content of particles of 1 μm or more in a releasing agent dispersion.

Note that the releasing agent content of the toner of the present invention is not particularly limited and can be appropriately determined depending on the intended use; however, it is preferably 1% by mass to 10% by mass.

### (Colorants)

As a colorant used in the present invention, any well-known dyes and pigments can be used. They include, for example, carbon black, nigrosine dye, iron black, Naphthol Yellow S, Hansa Yellow (10G, 5G, G), Cadmium Yellow, yellow iron oxide, yellow ocher, Chrome Yellow, Titanium Yellow, Polyazo Yellow, Oil Yellow, Hansa Yellow (GR, A, RN, R), Pigment Yellow L, Benzidine Yellow (G, GR), Permanent Yellow (NCG), Balkan Fast Yellow (5G, R), Tartrazine Lake, Quinoline Yellow Lake, Anthrazane Yellow BGL, Isoindolinone Yellow, red ocher, red lead, lead vermillion, Cadmium Red, Cadmium Mercury Red, Antimony Vermilion, Permanent Red 4R, Para Red, Fisay Red parachloroorthonitroaniline red, Resol Fast Scarlet G, Brilliant Fast Scarlet, Brilliant Carmine BS, Permanent Red (F2R, F4R, FRL, FRLL, F4RH), Fast Scarlet VD, Balkan Fast Rubin B, Brilliant Scarlet G, Resol Rubin GX, Permanent Red F5R, Brilliant Carmine 6B, Pigment Scarlet 3B, Bordeaux 5B, Toluidine Maroon, Permanent Bordeaux F2K, Hello Bordeaux BL, Bordeaux 10B, Bon Maroon Light, Bon Maroon Medium, Eosine Lake, Rhodamine Lake B, Rhodamine Lake Y, Alizarin Lake, Thioindigo Red B, Thioindigo Maroon, Oil Red, Quinacridone Red, Pyrazolone Red, Polyazo Red, Chromium Vermilion, Benzidine Orange, Perinone Orange, Oil Orange, Cobalt Blue, Cerulean Blue, Alkali Blue Lake, Peacock Blue Lake, Victoria Blue Lake, Non-metallic Phthalocyanine Blue, Phthalocyanine Blue, Fast Sky Blue, Indanthrene Blue (RS, BC), indigo, Ultramarine Blue, Berlin Blue, Anthraquinone Blue, Fast Violet B, Methyl Violet Lake, Cobalt Purple, Manganese Purple, Dioxane Violet, Anthraquinone Violet, Chrome Green, Zinc Green, chrome oxide, viridian, emerald Green, Pigment Green B, Naphthol Green B, Green Gold, Acid Green Lake, Malachite Green Lake, Phthalocyanine Green, Anthraquinone Green, titanium oxide, Zinc White, lithopone, and a mixture thereof. The content of a colorant is commonly 1% by mass to 15% by mass, preferably 3% by mass to 10% by mass with respect to the toner.

A colorant used in the present invention may be used as a master batch composited with a resin. A binder resin for manufacture of a master batch or for being kneaded with a master batch includes above-mentioned modified and unmodified polyester resins, and besides includes polymers of styrene and substituted styrenes such as polystyrenes, poly-p-chlorostyrenes and polyvinyltoluenes; styrenic copolymers such as styrene-p-chlorostyrene copolymers, styrene-propylene copolymers, styrene vinyltoluene copolymers, styrene vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-methyl α-chloromethacrylate copolymers, styrene-acrylonitrile copolymers, styrene-vinyl methyl ketone copolymers, styrene-butadiene copolymers, styrene-isoprene copolymers, styrene-acrylonitrile -indene copolymers, styrene-maleic acid copolymers and styrene maleate copolymers; polymethyl methacrylates, polybutyl methacrylates, polyvinyl chlorides, polyvinyl acetates, polyethylenes, polypropylenes, polyesters, epoxy resins, epoxy polyol resins, polyurethanes, polyamides, polyvinyl butyrals, polyacrylic resins, rosins, denaturated rosins, terpene resins, aliphatic or alicyclic hydrocarbon resins, aromatic petroleum resins, chlorinated paraffins, and paraffin waxes. These may be used singly or as a mixture thereof.

Further, for reducing the viscosity of a dispersion medium containing a toner composition, a solvent in which a polyester such as a urea-modified polyester or a prepolymer (A) is soluble may be used. Use of a solvent is preferable because of providing a sharper particle diameter distribution.

The solvent preferably has a volatility having a boiling point of less than 100° C. because of being easily removed. As the solvent, for example, toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone and methyl isobutyl ketone may be used singly or in a combination of two or more. Especially aromatic solvents such as toluene and xylene, and halogenated hydrocarbons such as methylene chloride, 1,2-dichloroethane, chloroform and carbon tetrachloride are preferable. The using amount of a solvent to 100 parts of a prepolymer (A) is commonly 0 to 300 parts, preferably 0 to 100 parts, further preferably 25 parts to 70 parts. When a solvent is used, after the extension and/or crosslinking reaction of a modified polyester (prepolymer) with an amine, the solvent is removed from the obtained reaction product under ordinary pressure or reduced pressure.

The master batch can be obtained by mixing and kneading a resin and a colorant for the master batch while applying a high shearing force. At this time, for enhancing the interaction of the colorant and the resin, an organic solvent can be used. The so-called flushing method in which an aqueous paste containing water of the colorant is mixed and kneaded with a resin and an organic solvent and then, the colorant is made to move to the resin side to remove the moisture and the organic solvent component, is favorably used because of no need for drying since the wet cake of the colorant can be used as it is. For mixing and kneading, a high-shearing dispersion apparatus such as a three-roller mill is favorably used.

For attaching and immobilizing a charge control agent on a toner particle surface, a manufacturing method of an electrographic toner is known in which particles containing a colorant and a resin and particles composed of at least charge control agent particles are mixed using a rotary body in a vessel, but the present invention can provide objective toner particles by including a process in which particles are mixed with the circumferential speed of a rotary body of 40 m/sec to 150 m/sec in a vessel which has no fixed members projected from the inner wall of the vessel as would be present in the known method. Then, the used toner will be described.

The toner of the present invention may contain a charge control agent as required. As a charge control agent, well-known ones can be used, and are, for example, nigrosine dyes, triphenylmethane dyes, chromium-containing metal complex dyes, molybdic acid chelate pigments, rhodamine dyes, alkoxyamines, quaternary ammonium salts (including fluorine-modified quaternary ammonium salts), alkylamides, phosphorus as a single substance or its compounds, tungsten as a single substance or its compounds, fluorine-containing activators, salicylic acid metal salts and metal salts of salicylic acid derivatives. The charge control agent specifically includes Bontron 03 of a nigrosine dye, Bontron P-51 of a quaternary ammonium salt, Bontron S-34 of a metal-containing azo dye, E-82 of an oxynaphthoic acid metal complex, E-84 of a salicylic acid metal complex and E-89 of a phenolic condensate (hereinbefore, made by Orient Chemical Industries, Ltd.), TP-302 and TP-415 of quaternary ammonium salt molybdenum complexes (made by Hodogaya Chemical Co., Ltd.), Copy Charge PSY VP2038 of a quaternary ammonium salt, Copy Blue PR of a triphenylmethane derivative, Copy Charge NEG VP2036 of a quaternary ammonium salt and Copy Charge NX VP434 (made by Hoechst A.G.), LRA-901, and LR-147 of a boron complex (made by Japan Carlit Co., Ltd.), copper phthalocyanine, perylene, quinacridone, azo pigments, and besides, polymer compounds having functional groups such as a sulfonic acid group, a carboxyl groups and a quaternary ammonium salt.

The using amount of a charge control agent in the present invention is determined by a toner manufacturing method including the type of binder resin, presence/absence of additives used as required and a dispersing method, and is not definitely determined, but is preferably in the range of 0.1 part to 10 parts to 100 parts of a binder resin, more preferably in the range of 0.2 part to 5 parts. With the amount exceeding 10 parts, the chargeability of a toner is too large; the effect of the charge control agent diminishes; the electrostatic attractive force against a developing roller increases; and the fluidity of a developer decreases and the image decreases. The charge control agent and the releasing agent may be melted and kneaded with a master batch and a resin, or may be of course added when they are dissolved or dispersed in an organic solvent.

External additives are used for aiding the fluidity, developability and chargeability of colored particles obtained in the present invention. As an external additive, inorganic fine particles are preferably used. The inorganic fine particles preferably have a primary particle diameter of 5 nm to 2 μm, especially preferably 5 nm to 500 nm. The specific surface area is by the BET method is preferably 20 m²/g to 500 m²/g. The using proportion of the inorganic fine particles is preferably 0.01% by mass to 5% by mass to a toner, especially preferably 0.01% by mass to 2.0% by mass. The inorganic fine particles include, for example, silica, alumina, titanium oxide, barium titanate, magnesium titanate, calcium titanate, strontium titanate, zinc oxide, tin oxide, quartz sand, clay, mica, wollastonite, diatomaceous earth, chrome oxide, cerium oxide, red iron oxide, antimony trioxide, magnesium oxide, zirconium oxide, barium sulfate, barium carbonate, calcium carbonate, silicon carbide and silicon nitride. Among these, as a fluidity promoter, the concurrent use of hydrophobic silica fine particles and hydrophobic titanium oxide fine particles is preferable. It has been found that especially when both the fine particles having an average particle diameter of 50 nm or less are used to stir and mix, since the electrostatic force and van der Waals force with a toner remarkably improve, even by being subjected to stirring and mixing inside a developing machine for obtaining a desired charge level, the fluidity promoter never drop off the toner; a favorable image quality in which fireflies and the like do not generate can be obtained; further, the residual toner after transferring can be reduced evidently.

While the titanium oxide fine particles are excellent in the environmental stability and the image density stability, it has a tendency of worsening the charge rising characteristic and if the loading amount of the titanium oxide fine particles is more than that of the silica fine particles, the influence of a side-effect of the charge rising characteristic conceivably becomes large. In the case of the loading amounts of the hydrophobic silica fine particles and the hydrophobic titanium oxide fine particles in the range of 0.3% by mass to 1.5% by mass, the charge rising characteristic is not largely damaged and a desired charge rising characteristic is obtained, that is, even when copying is repeated, it is found that a stable image quality is obtained and the toner blow can be suppressed.

A resin for a toner binder can be manufactured by the following method and the like. A polyol (PO) and a polycarboxylic acid (PC) are heated at 150° C. to 280° C. under the presence of a well-known esterification catalyst such as tetrabutoxytitanate or dibutyltin oxide; and generated water is distilled away optionally under reduced pressure to obtain a polyester having a hydroxyl group. Then, the polyester is reacted with a polyisocyanate (PIC) at 40° C. to 140° C. to obtain a polyester prepolymer (A) having an isocyanate group. Further, the A is reacted with amines (B) at 0° C. to 140° C. to obtain a polyester (UMPE) modified with urea bond. The modified polyester has a number-average molecular weight of 1,000 to 10,000, preferably 1,500 to 6,000. When PIC is reacted, and when A and B are reacted, a solvent may be used as required. Usable solvents include compounds inert to isocyanates (PIC) such as aromatic solvents (toluene, xylene, etc.); ketones (acetone, methyl ethyl ketone, methyl isobutyl ketone, etc.); esters (ethyl acetate, etc.); amides (dimethylformamide, dimethylacetamide, etc.); and ethers (tetrahydrofuran, etc.). When a polyester (PE) which is not modified with urea bond is concurrently used, a PE is manufactured by a method similar to the case of the polyester having a hydroxyl group and the PE is dissolved and mixed in the solution of the above-mentioned UMPE after the reaction is completed.

The toner of the present invention can be manufactured by the following methods, but the methods are not limited thereto.

### (Manufacturing Method of a Toner in an Aqueous Medium)

An aqueous medium used in the present invention may be water alone, but may be used concurrently with a solvent miscible with water. The miscible solvents include alcohols (methanol, isopropanol, ethylene glycol, etc.), dimethylformamide, tetrahydrofuran, cellosolves (methyl cellosolve, etc.), and lower ketones (acetone, methyl ethyl ketone, etc.).

In the present invention, a reactive modified polyester such as a polyester prepolymer (A) having an isocyanate group is reacted with an amine (B) in an aqueous medium to obtain a urea-modified polyester (UMPE) and the like. A method for stably forming a dispersion composed of a modified polyester such as a urea-modified polyester and a reactive modified polyester such as a prepolymer (A) in an aqueous medium includes a method in which compositional components of toner raw materials composed of a modified polyester such as a urea-modified polyester and a reactive modified polyester such as a prepolymer (A) are added in an aqueous medium, and dispersed by a shearing force. A reactive modified polyester such as a prepolymer (A) and other toner compositional components (hereinafter, referred to as toner raw materials), a colorant, a colorant master batch, a releasing agent, a charge control agent, an unmodified polyester resin, etc., may be mixed when a dispersion is formed in an aqueous medium, but it is more preferable that after the toner raw materials be previously mixed, the mixture be added and dispersed in an aqueous medium. In the present invention, other toner raw materials such as a colorant, a releasing agent and a charge control agent must not always be previously mixed when particles are formed in an aqueous medium, but after particles are formed, the other toner raw materials may be added. For example, after particles not containing a colorant are formed, the colorant may be added by a well-known dyeing method.

A method for dispersing is not especially limited, but well-known facilities such as of low-speed shearing type, high-speed shearing type, friction type, high-pressure jetting type and ultrasonic type are applicable. For making a dispersion with a particle diameter of 2 μm to 20 μm, a high-seed shearing type is preferable. In the case of using a high-speed shearing type disperser, the rotation frequency is not especially limited, but is commonly 1,000 rpm to 30,000 rpm, preferably 5,000 rpm to 20,000 rpm. The dispersing time is not especially limited, but is commonly 0.1 min to 5 min in the case of a batch type. The temperature at dispersing is commonly 0° C. to 150° C. (under pressure), preferably 40° C. to 98° C. At a higher temperature, the viscosity of a dispersion composed of a urea-modified polyester and a prepolymer (A) is lower, which is preferable in view of easy dispersing.

The using amount of an aqueous medium to 100 parts of toner compositional components containing polyesters such as a urea-modified polyester and a prepolymer (A) is commonly 50 parts to 2,000 parts, preferably 100 parts to 1,000 parts. With the amount of less than 50 parts, the dispersion state of the toner composition is bad and toner particles having a predetermined particle diameter cannot be obtained. The amount exceeding 20,000 parts is not economical. As required, a dispersant may be used. Use of a dispersant is preferable in view of a sharp particle diameter distribution and a stable dispersion.

In a liquid in which an oil phase in which a toner composition is dispersed contains water, various types of dispersants for emulsifying and dispersing are used. Such dispersants include surfactants, inorganic fine particle dispersants and polymer fine particle dispersants.

Surfactants include anionic surfactants such as alkylbenzenesulfonates, α-olefin sulfonates and phosphoric acid ester, amine salt types such as alkylamine salts, aminoalcohol fatty acid derivatives, polyamine fatty acid derivatives and imidazoline salts, cationic surfactants of quaternary-ammonium-salt type such as alkyltrimethylammonium salts, dialkyldimethylammonium salts, alkyldimethylbenzylammonium salts, pyridinium salts, alkylisoquinolinium salts and benzethonium chloride, nonionic surfactants such as fatty acid amide derivatives and polyhydric alcohol derivatives, and amphoteric surfactants such as alanine, dodecyldi(aminoethyl)glycine, di(octylaminoethyl)glycine and N-alkyl-N,N-dimethylammonium betaine.

Use of a surfactant having a fluoroalkyl group can exhibit its effect in a very small amount. Preferably used anionic surfactants having a fluoroalkyl group include fluoroalkylcarboxylic acids having 2 to 10 carbon atoms and their metal salts, disodium perfluorooctanesulfonylglutamate, sodium 3-[omega-fluoroalkyl(C6-C11)oxy]-1-alkyl(C3-C4)sulfonates, sodium 3-[omega-fluoroalkanoyl(C6-C8)-N-ethylamino]-1-propanesulfonates, fluoroalkyl(C11-C20)carboxylic acids and their metal salts, perfluoroalkyl(C7-C13)carboxylic acids and their metal salts, perfluoroalkyl(C4-C12)sulfonic acids and their metal salts, perfluorooctanesulfonic acid diethanolamide, N-propyl-N-(2-hydroxyethyl)perfluorooctanesulfonamide, perfluoroalkyl(C6-C10)sulfonamide propyltrimethylammonium salts, perfluoroalkyl(C6-C10)-N-ethylsulfonylglycine salts and monoperfluoroalkyl(C6-C16)ethylphosphoric esters.

These trade names include Surflon S-111, S-112 and S-113 (made by Asahi Glass Co., Ltd.), Florad FC-93, FC-95, FC-98 and FC-129 (made by Sumitomo 3M Inc.), Unidine DS-101 and DS-102 (made by Daikin Industries, Ltd.), Megafac F-110, F-120, F-113, F-191, F-812 and F-833 (made by Dainippon Ink and Chemicals, Inc.), Ectop EF-102, 103, 104, 105, 112, 123A, 123B, 306A, 501, 201 and 204, (Tochem Products Co., Ltd.), and Ftergent F-100 and F150 (made by Neos Co., Ltd.). Cationic surfactants include aliphatic primary, secondary or secondary amic acids having a fluoroalkyl group, aliphatic quaternary ammonium salts such as perfluoroalkyl(C6-C10)sulfonamide propyltrimethylammonium salts, benzalkonium salts, benzethonium chloride, pyridinium salts, and imidazolinium salts. Their trade names include Surflon S-121 (made by Asahi Glass Co., Ltd.), Florad FC-135 (made by Sumitomo 3M Inc.), Unidine DS-202 (made by Daikin Industries, Ltd.), Megafac F-150 and F-824 (made by Dainippon Ink and Chemicals, Inc.), Ectop EF-132 (made by Tochem Products Co., Ltd.), and Ftergent F-300 (made by Neos Co,. Ltd.). As inorganic compound dispersants hardly soluble in water, tricalcium phosphate, calcium carbonate, titanium oxide, colloidal silica, hydroxyapatite and the like are usable.

Use of resin fine particles can also provide an effect similar to inorganic dispersants. The resin fine particles include, for example, MMA polymer fine particles of 1 μm and 3 μm, styrene fine particles of 0.5 μm and 2 μm, and styrene-acrylonitrile fine particles of 1 μm (PB-200H (Kao Corp.), SGP (Sohken), Techpolymer SB (Sekisui), SGP-3G (Sohken), Micropearl (Sekisui)).

Dispersants concurrently usable with the inorganic dispersants and resin fine particles may be those obtained by stabilizing dispersion droplets with a polymer protective colloid. The usable dispersants include, for example, acids such as acrylic acid, methacrylic acid, α-cyanoacrylic acid, α-cyanomethacrylic acid, itaconic acid, crotonic acid, fumaric acid, maleic acid and maleic anhydride; (meth)acrylic monomers containing a hydroxyl group such as β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethylene glycol monoacrylic acid ester, diethylene glycol monomethacrylic acid ester, glycerol monoacrylic acid ester, glycerol monomethacrylic acid ester, N-methylolacrylamide and N-methylolmethacrylamide; vinylalcohols or ethers with vinylalcohols such as vinyl methyl ether, vinyl ethyl ether and vinyl propyl ether; esters of vinyl alcohols and compounds containing a carboxyl group, such as vinyl acetate, vinyl propionate and vinyl butyrate; acrylamide, methacrylamide, diacetone acrylamide, and methylol compounds thereof; acid chlorides such as acrylic acid chloride and methacrylic acid chloride; homopolymers or copolymers of compounds having a nitrogen atom or its heterocyclic ring, such as vinylpyridine, vinylpyrrolidone, vinylimidazole and ethyleneimine; polyoxyethylenes such as polyoxyethylene, polyoxypropylene, polyoxyethylene alkylamine, polyoxypropylene alkylamine, polyoxyethylene alkylamide, polyoxypropylene alkylamide, polyoxyethylene nonylphenyl ether, polyoxyethylene laurylphenyl ether, polyoxyethylene stearylphenyl ester and polyoxyethylene nonylphenyl ester; and celluloses such as methyl celluloses, hydroxyethyl celluloses and hydroxypropylcelluloses.

Further, for reducing the viscosity of a dispersion medium containing toner compositional components, a solvent which can dissolve the polyesters such as a urea-modified polyester and a prepolymer (A) can be used. Use of a solvent is more preferable in view of a sharp particle diameter distribution. The solvent preferably has a volatility having a boiling point of less than 100° C. in view of the easy removal of the solvent. The solvents include, for example, toluene, xylene, benzene, carbon tetrachloride, methylene chloride, 1,2-dichloroethane, 1,1,-trichloroethane, trichloroethylene, chloroform, monochlorobenzene, dichloroethylidene, methyl acetate, ethyl acetate, methyl ethyl ketone and methyl isobutyl ketone, and these may be used singly or in a combination of two or more. Especially, aromatic solvents such as toluene, xylene and halogenated hydrocarbons such as methylene chloride, 1,2-dichloroethane, chloroform and carbon tetrachloride are preferable. The using amount of a solvent to 100 parts of a prepolymer (A) is commonly 0 to 300 parts, preferably 0 to 100 parts, further preferably 25 parts to 70 parts. When a solvent is used, after the extension and/or crosslinking reaction of a modified polyester (prepolymer) with an amine, the solvent is removed from the resultant reaction product under ordinary pressure or reduced pressure.

The time of the extension and/or crosslinking reaction is selected, for example, according to the reactivity depending on a combination of an isocyanate group structure a prepolymer (A) has and amines (B), but is commonly 10 min to 40 hours, preferably 2 hours to 24 hours. The reaction temperature is commonly 0 to 150° C., preferably 40° C. to 98° C. Further, a well-known catalyst can be used optionally. The catalyst specifically includes dibutyltin laurate and dioctyltin laurate. As an extension and/or crosslinking agent, the above-mentioned amines (B) are used.

The ratio Dv/Dn of the volume average particle diameter Dv of a toner to the number average particle diameter (Dn) thereof can be controlled, mainly for example, by adjusting the water is phase viscosity, oil phase viscosity, characteristics of resin fine particles, loading amount and the like. The ratio also changes also with the wax dispersion particle diameter. Dv and Dn can be controlled, for example, by adjusting the characteristics of resin fine particles, loading amount and the like.

Toner particles have preferably particles of 2 μm or less accounting for 1% by number to 20% by number, more preferably 1% by number to 10% by number. Beyond this range, since micropowder components increase, the charging quantity distribution sometimes becomes broad, and the exposing states of toner particles and the dispersion states of the toner composition are sometimes different between the micropowder components and the components of fine particles having an average particle diameter, whereby the image quality cannot be maintained.

The toner of the present invention can be used as a two-component developer. In this case, the toner is mixed with a magnetic carrier, and the content ratio of a carrier to a toner in a developer is preferably 1 part to 10 parts of the toner to 100 parts of the carrier. As a magnetic carrier, conventional well-known ones can be used such as an iron powder, ferrite powder, magnetite powder and magnetic resin carrier which have a particle diameter of about 20 μm to 200 μm. Coating materials include amino resins, for example, urea-formaldehyde resins, melamine resins, benzoguanamine resins, urea resins, polyamide resins, and epoxy resins. Further, polyvinyl and polyvinylidene resins, for example, acrylic resins, polymethyl methacrylate resins, polyacrylonitrile resins, polyvinyl acetate resins, polyvinyl alcohol resins, polyvinyl butyral resins, polystyrenic resins such as polystyrene resins and styrene-acrylic copolymer resins, halogenated olefin resins such as polyvinyl chlorides, polyester resins such as polyethylene terephthalate resins and polybutyrene terephthalate resins, polycarbonate resins, polyethylene resins, polyvinyl fluoride resins, polyvinylidene fluoride resins, polytrifluoroethylene resins, polyhexafluoropropylene resins, copolymers of vinylidene fluoride and an acrylic monomer, copolymers of vinylidene fluoride and vinyl fluoride, fluoroterpolymers such as a terpolymer of tetrafluoroethylene, vinylidene fluoride and a non-fluorinated monomer, and silicone resins, can be used. Further, as required, a conductive powder and the like may be contained in a coating resin. As a conductive powder, a metal powder, carbon black, titanium oxide, tin oxide, zinc oxide and the like can be used. These conductive powders preferably have an average particle diameter of 1 μm or less. With the average particle diameter of more than 1 μm, the control of the electric resistance becomes difficult.

The toner of the present invention can be used as a one-component magnetic toner which does not use a carrier, or a non-magnetic toner.

The image forming method of the present invention is a method in which the toner of the present invention is used as a toner in a conventional image forming method using a toner.

The image forming apparatus of the present invention is an apparatus in which the toner of the present invention is used as a toner in a conventional image forming apparatus using a toner.

Hereinafter, the present invention will be described referring to drawings.

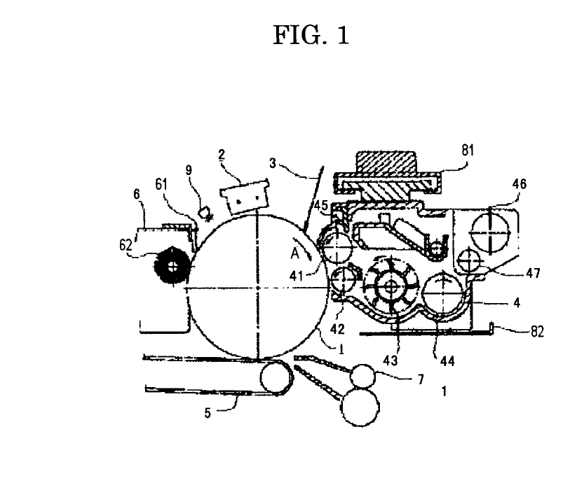

FIG. 1 is a principal portion sectional constitution view of one example of image forming apparatuses. In this example, an electrophotographic copying machine is exemplified as an image forming apparatus. In FIG. 1, numerical reference 1 denotes a photoreceptor drum as a latent electrostatic image bearing member (i.e. a toner image bearing member), which rotates in the arrow direction in the drawing, around which a charging device 2 is arranged, and on which a laser light beam 3 corresponding to images read from a manuscript is irradiated as an exposing unit. Further, around the photoreceptor 1, a developing device 4, a paper-feed unit 7, a transferring device 5, a cleaning device 6 and a discharging lamp 9 are arranged. The developing device 4 is further equipped with developing rollers 41 and 42, a paddle-shaped agitation member 43, an agitation member 44, a doctor 45, a toner replenishing section 46 and a replenishing roller 47. The cleaning device 6 is equipped with a cleaning brush 62 and a cleaning blade 61. Members 81 and 82 arranged above and below the developing device 4 are guide rails to attach/detach the developing device on/from or support it. The lifetime of the cleaning blade 61 of the cleaning device can be detected. The cleaning blade 61 always contacts with the photoreceptor during forming images and wears involved in the rotation of the photoreceptor. The wear of the cleaning blade decreases the removal function of the residual toner on the photoreceptor surface and deteriorates the copy image quality. Even if there is no wear, if the toner has a shape of nearly a true sphere and is improved in fluidity as compared with a crushed-type toner, although the transferability is improved, the toner passes through an installed blade in cleaning and are liable to generate cleaning faults, which is said to be a problem with a polymerized toner. Use of the toner of the present invention for this problem can provide favorable cleaning.

### (Process Cartridge)

The toner of the present invention is contained in a developer container of a process cartridge and the process cartridge is mounted in an image forming apparatus.

The process cartridge contains a latent electrostatic image bearing member (i.e. a toner image bearing member) to carry latent electrostatic images, and a developing unit to develop the electrostatic latent images formed on the latent electrostatic image bearing by using a developer to form visible images, and is further constituted of other units, which are optionally suitably selected, such as a charging unit, an exposing unit, a developing unit, a transferring unit, a cleaning unit and a discharging unit.

The developing unit is constituted at least of a developer container to contain the toner or the developer of the present invention and an electrostatic latent image carrying body to carry and transport the toner or the developer contained in the developer container, and may be constituted of a layer thickness restricting member to restrict the carried toner layer thickness, and the like.

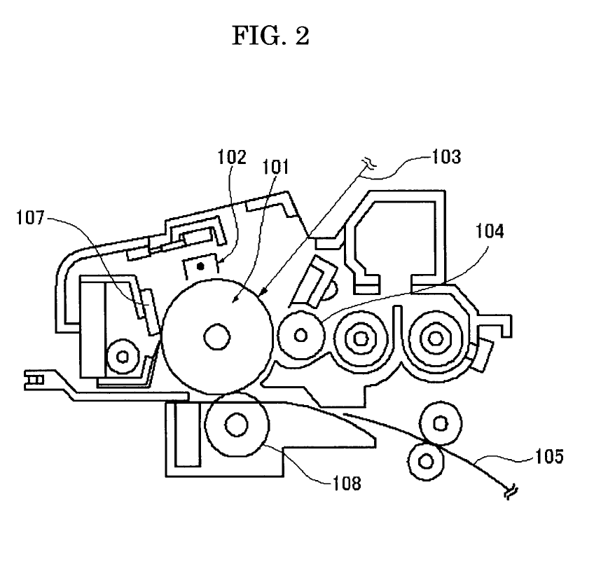

Here, the process cartridge builds in, for example, a photoreceptor (101) as shown in FIG. 2, and is further constituted of a charging unit (102), a developing unit (104) and a cleaning unit (107), and further optionally other members. The process cartridge example of FIG. 2 has a transferring unit (108) to transfer toner images on the developed photoreceptor (101) to an image receiving paper (105).

As the photoreceptor (101), the above-mentioned one can be used.

As the exposing unit (103), a light source capable of writing with a high resolution is used.

As the charging unit (102), any charging unit is used.

### EXAMPLES

Hereinafter, the present invention will be further described by way of examples, but the scope of the present invention is not limited thereto. Hereinafter, “parts” denotes parts by mass.

### Examples A1 to A6 and Comparative Examples A1 to A5

### (Production Example of Polyester)

In a reaction vessel equipped with a cooling tube, a stirrer and a nitrogen introducing tube, 690 parts of an adduct of 2 moles of ethylene oxide to bisphenol A and 256 parts of terephthalic acid were polycondensated under ordinary pressure at 230° C. for 8 hours, allowed to react under a reduced pressure of 10 mmHg to 15 mmHg for 5 hours and then cooled to 160° C.; 18 parts of phthalic anhydride was added thereto and allowed to react for 2 hours to obtain an unmodified polyester (A1). The obtained polyester (A1) had a weight-average molecular weight of 4,000, an acid value of 10 KOH mg/g and a glass transition temperature of 50° C.

### (Production Example of Prepolymer)

In a reaction vessel equipped with a cooling tube, a stirrer and a nitrogen introducing tube, 800 parts of an adduct of 2 moles of ethylene oxide to bisphenol A, 180 parts of isophthalic acid, 60 parts of terephthalic acid and 2 parts of dibutyltin oxide were charged and allowed to react under ordinary pressure at 23° C. for 8 hours, and further allowed to react under a reduced pressure of 10 mmHg to 15 mmHg for 5 hours while being dehydrated, and then cooled to 160° C.; and 32 parts of phthalic anhydride was added thereto and allowed to react for 2 hours.

Then, the reaction product was cooled to 80 ° C., and allowed to react with 170 parts of isophorone diisocyanate in ethyl acetate for 2 hours to obtain an isocyanate group-containing prepolymer [Prepolymer A1].

### (Production Example pf Ketimine Compound)

In a reaction vessel equipped with a stirring rod and a thermometer, 30 parts of isophorone diamine and 70 parts of methyl ethyl ketone were charged, and allowed to react at 50° C. for 5 hours to obtain [Ketimine Compound A1].

### (Preparation Example of Wax Dispersion A1)

70 parts of ethyl acetate, 25 parts of the polyester (A1), 5 parts of a carnauba wax (melting point: 82° C.) as a wax and further 60% by volume ratio of zirconia of 3 mm were charged and stirred by a Paint Conditioner No. 5400 (made by Red Devil Equipment Co. in U.S.) for 24 hours to obtain [Wax Dispersion A1]. The volume average particle diameter (average dispersed particle diameter) of wax dispersion particles contained in the obtained [Wax Dispersion A1]was measured by a particle size distribution analyzer (“LA-920”; made by Horiba Ltd.) using the laser scattering method, and was 0.25 μm.

### (Preparation Example of Wax Dispersion A2)

70 parts of ethyl acetate, 25 parts of the polyester (A1), 5 parts of a carnauba wax (melting point: 82° C.) as a wax and further 60% by volume ratio of zirconia of 3 mm were charged and stirred by a Paint Conditioner No. 5400 (made by Red Devil Equipment Co. in U.S.) for 36 hours to obtain [Wax Dispersion A2]. The volume average particle diameter (Dv) of wax dispersion particles contained in the obtained [Wax Dispersion A2] was measured by a particle size distribution analyzer (“LA-920”; made by Horiba Ltd.) using the laser scattering method, and was 0.16 μm.

### (Preparation Example of Wax Dispersion A3)

70 parts of ethyl acetate, 25 parts of the polyester (A1), 5 parts of a carnauba wax (melting point: 82° C.) as a wax and further 60% by volume ratio of zirconia of 3 mm were charged and stirred by a Paint conditioner No. 5400 (made by Red Devil Equipment Co. in U.S.) for 48 hours to obtain [Wax Dispersion A3]. The volume average particle diameter (Dv) of wax dispersion particles contained in the obtained [Wax Dispersion A3] was measured by a particle diameter distribution analyzer (“LA-920”; made by Horiba Ltd.) using the laser scattering method, and was 0.11 μm.

### (Preparation Example of Wax Dispersion A4)

70 parts of ethyl acetate, 25 parts of the polyester (A1), 5 parts of a carnauba wax (melting point: 82° C.) as a wax and further 60% by volume ratio of zirconia of 3 mm were charged and stirred by a Paint conditioner No. 5400 (made by Red Devil Equipment Co. in U.S.) for 12 hours to obtain [Wax Dispersion A4]. The volume average particle diameter (Dv) of wax dispersion particles contained in the obtained [Wax Dispersion A4] was measured by a particle diameter distribution analyzer (“LA-920”; made by Horiba Ltd.) using the laser scattering method, and was 0.46 μm.

### (Preparation Example of Wax Dispersion A5)

70 parts of ethyl acetate, 25 parts of the polyester (A1), 5 parts of a carnauba wax (melting point: 70° C.) as a wax and further 60% by volume ratio of zirconia of 3 mm were charged and stirred by a Paint Conditioner No. 5400 (made by Red Devil Equipment Co. in U.S.) for 24 hours to obtain [Wax Dispersion A5]. The volume average particle diameter (Dv) of wax dispersion particles contained in the obtained [Wax Dispersion A5] was measured by a particle diameter distribution analyzer (“LA-920”; made by Horiba Ltd.) using the laser scattering method, and was 0.24 μm.

### (Preparation Example of Wax Dispersion A6)

70 parts of ethyl acetate, 25 parts of the polyester (A1), 5 parts of a carnauba wax (melting point: 82° C.) as a wax and further 60% by volume ratio of zirconia of 3 mm were charged and stirred by a Paint Conditioner No. 5400 (made by Red Devil Equipment Co. in U.S.) for 5 hours to obtain [Wax Dispersion A6]. The volume average particle diameter (Dv) of wax dispersion particles contained in the obtained [Wax Dispersion A6] was measured by a particle size distribution analyzer (“LA-920”; made by Horiba Ltd.) using the laser scattering method, and was 0.53 μm.

### (Preparation Example of Wax Dispersion A7)

70 parts of ethyl acetate, 25 parts of the polyester (A1), 5 parts of a carnauba wax (melting point: 82° C.) as a wax and further 60% by volume ratio of zirconia of 3 mm were charged and stirred by a Paint Conditioner No. 5400 (made by Red Devil Equipment Co. in U.S.) for 72 hours to obtain [Wax Dispersion A7]. The volume average particle diameter (Dv) of wax dispersion particles contained in the obtained [Wax Dispersion A7] was measured by a particle size distribution analyzer (“LA-920”; made by Horiba Ltd.) using the laser scattering method, and was 0.09 μm.

### (Preparation Example of Wax Dispersion A8)

70 parts of ethyl acetate, 25 parts of the polyester (A1), 5 parts of a carnauba wax (melting point: 70° C.) as a wax and further 60% by volume ratio of zirconia of 3 mm were charged and stirred by a Paint Conditioner No. 5400 (made by Red Devil Equipment Co. in U.S.) for 3 hours to obtain [Wax Dispersion A8]. The volume average particle diameter (Dv) of wax dispersion particles contained in the obtained [Wax Dispersion A8] was measured by a particle size distribution analyzer (“LA-920”; made by Horiba Ltd.) using the laser scattering method, and was 0.62 μm.

### (Production of Kneaded Composite 1 of Modified Layered Inorganic Mineral and Binder Resin)

1,200 parts of water, 174 parts of BENTONE 57 made by Elementis Specialties, Inc. (an organic-modified bentonite, a quaternary ammonium cation-modified product) and 1,570 parts of [Polyester A1] were mixed by a Henschel mixer (made by Mitsui Mining Co., Ltd.). The mixture was kneaded by a two-roll kneader at 150° C. for 30 min, then rolled and cooled, and pulverized by a pulverizer (made by Hosokawa Micron Corp.) to prepare [Kneaded Composite 1 of Modified Layered Inorganic Mineral and Binder Resin].

### (Production of Kneaded Composite 2 of Modified Layered Inorganic Mineral and Binder Resin)

1,200 parts of water, 525 parts of S-Ben WX525 made by Hojun Co., Ltd., and 1,225 parts of [Polyester A1] were mixed by a Henschel mixer (made by Mitsui Mining Co., Ltd.). The mixture was kneaded by a two-roll kneader at 150° C. for 30 min, then rolled and cooled, and pulverized by a pulverizer (made by Hosokawa Micron Corp.) to prepare [Kneaded Composite 2 of Modified Layered Inorganic Mineral and Binder Resin].

### (Production of Kneaded Composite 3 of Modified Layered Inorganic Mineral and Binder Resin)

1,200 parts of water, 525 parts of BENTONE 57 made by Elementis Specialties, Inc. and 1,225 parts of [Polyester A1] were mixed by a Henschel mixer (made by Mitsui Mining Co., Ltd.). The mixture was kneaded by a two-roll kneader at 150° C. for 30 min, then rolled and cooled, and pulverized by a pulverizer (made by Hosokawa Micron Corp.) to prepare [Kneaded Composite 3 of Modified Layered Inorganic Mineral and Binder Resin].

### (Production of Kneaded Composite 4 of Modified Layered Inorganic Mineral and Binder Resin)

1,200 parts of water, 525 parts of BENTONE 57 made by Elementis Specialties, Inc. and 1,225 parts of [Polyester A1] were mixed by a Henschel mixer (made by Mitsui Mining Co., Ltd.). The mixture was kneaded by a two-roll kneader at 150° C. for 60 min, then rolled and cooled, and pulverized by a pulverizer (made by Hosokawa Micron Corp.) to prepare [Kneaded Composite 4 of Modified Layered Inorganic Mineral and Binder Resin].

### (Production of Kneaded Composite 5 of Modified Layered Inorganic Mineral and Binder Resin)

1,200 parts of water, 525 parts of BENTONE 57 made by Elementis Specialties, Inc. and 1,225 parts of [Polyester A1] were mixed by a Henschel mixer (made by Mitsui Mining Co., Ltd.). The mixture was kneaded by a two-roll kneader at 150° C. for 15 min, then rolled and cooled, and pulverized by a pulverizer (made by Hosokawa Micron Corp.) to prepare [Kneaded Composite 5 of Modified Layered Inorganic Mineral and Binder Resin].

### (Preparation of Organic Resin Fine Particle Dispersion)

In a reaction vessel equipped with a stirring rod and a thermometer, 683 parts of water, 20 parts of a sodium salt of a sulfate of a methacrylic acid-ethylene oxide adduct (“Eleminol RS-30”, made by Sanyo Chemical Industries, Ltd.), 78 parts of styrene, 78 parts of methacrylic acid, 120 parts of butyl acrylate and 1 part of ammonium persulfate were charged, and stirred at 400 rpm for 15 min to obtain a white emulsion. The emulsion was heated to a temperature in the system of 75° C. and allowed to react for 5 hours. Then, 30 parts of a 1-mass % ammonium persulfate aqueous solution was added to the reaction product, and aged at 75° C. for 5 hours to prepare an aqueous dispersion of vinyl resin particles (copolymer of styrene-methacrylic acid-butyl acrylate-sodium salt of a sulfate of a methacrylic acid-ethylene oxide adduct) (Resin Fine Particle Dispersion A1).

The volume average particle diameter (Dv) of the organic resin fine particles contained in the obtained organic resin fine particle dispersion was measured by a particle size distribution analyzer (“nanotracUPA-150EX”; made by Nikkiso Co., Ltd.), and was 55 nm.

### (Preparation of Water Phase)

990 parts of water, 83 parts of the [resin fine particle dispersion A1], 37 parts of a 48.5% aqueous solution of sodium dodecyldiphenyl ether disulfonate (Eleminol MON-7; made by Sanyo Chemical Industries, Ltd.) and 90 parts of ethyl acetate were mixed and stirred to obtain a milky white liquid. This liquid was named [Water Phase 1].

### (Synthesis of MB)

In a reaction vessel equipped with a cooling tube, a stirrer and a nitrogen introducing tube, 319 parts of an adduct of 2 moles of propylene oxide to bisphenol A, 449 parts of an adduct of 2 moles of ethylene oxide to bisphenol A, 243 parts of terephthalic acid, 53 parts of adipic acid and 2 parts of dibutyltin oxide were charged, allowed to react under ordinary pressure at 230° C. for 8 hours, and further allowed to react under a reduced pressure of 10 mmHg to 15 mmHg for 5 hours; and thereafter, 7 parts of trimellitic anhydride was added to the reaction vessel and allowed to react at 180° C. under ordinary pressure for 2 hours to obtain [Polyester A1 for MB]. [Polyester A1 for MB] had a number-average molecular weight of 1,900, a mass-average molecular weight of 6,100, a Tg of 43° C. and an acid value of 1.1.

30 parts of water, 40 parts of C. I. PigmentRed 122 (Magenta R; made by Toyo Ink Mfg. Co., Ltd. and 60 parts of [Polyester A1 for MB] were added and mixed in a Henschel mixer (made by Mitsui Mining Co., Ltd.) to obtain a mixture in which water penetrates into pigment aggregates. The mixture was kneaded by a two-roll kneader at 130° C. for 45 min, then rolled and cooled, and pulverized by a pulverizer to obtain [Master Batch A1].

### Example A1

### (Preparation of Oil Phase)

In a vessel equipped with a stirring rod and a thermometer, 30 parts of a 65% ethyl acetate solution of [Polyester A1], 50 parts of [Wax Dispersion 1] and 20 parts of a 50% ethyl acetate solution of [Master Batch A1] were charged, heated to 80° C. while being stirred, held at 80° C. for 5 hours, and then cooled to 30° C. spending 1 hour to obtain [Pigment/Wax Dispersion A1].

### (Emulsification→Desolvation)

664 parts of [Pigment/Wax Dispersion A1], 139 parts of [Prepolymer A1], 5.9 parts of [Ketimine Compound A1] and 120 parts of a 50% ethyl acetate solution of [Kneaded Composite A1 of Modified Layered Inorganic Mineral and Binder Resin] were charged in a vessel, mixed by a T.K. Homomixer (made by Primix Corp.) at 5,000 rpm for 1 min; and then 1,200 parts of [Water Phase A1] was added to the vessel, and mixed by a T.K. Homomixer at a rotation frequency of 10,000 rpm for 20 min to obtain [Emulsified Slurry A1].

In a vessel equipped with a stirring rod and a thermometer, [Emulsified Slurry A1] was charged, and desolvated at 30° C. for 8 hours to obtain [Emulsified Slurry A1].

### (Washing→Drying)

100 parts of [Emulsified slurry A1] was filtered under reduced pressure; thereafter, 100 parts of ion exchange water was added to the filter cake; and the resultant filter cake was mixed by a T.K. Homomixer of a rotation (at a rotation frequency of 12,000 rpm for 10 min) and then filtered. 100 parts of a 10% sodium hydroxide aqueous solution was added to the resultant filter cake, mixed by a T.K. Homomixer (at a rotation frequency of 12,000 rpm for 30 min), and then filtered under reduced pressure. 100 parts of a 10% hydrochloric acid solution was added to the resultant filter cake, mixed by a T.K. Homomixer (at a rotation frequency of 12,000 rpm for 10 min), and then filtered. 300 parts of ion exchange water was added to the resultant filter cake, mixed by a T.K. Homomixer (at a rotation frequency of 12,000 rpm for 10 min), and then filtered, which operations were twice repeated to obtain [Filter Cake A1].

[Filter Cake A1] was dried in an air-circulating drier at 40° C. for 48 hours, and sifted through a mesh of 75 μm in aperture; thereafter, 100 parts of the obtained toner base particles, and 0.5 parts of a hydrophobic silica (hexamethyldisilazane-surface-treated product; specific surface area: 200 m²/g) and 0.5 part of a hydrophobized rutile-type titanium oxide (isobutyltrimethoxysilane-surface-treated product; average primary particle diameter: 0.02 μm) were mixed by a Henschel mixer to obtain Toner (A1).

### Example A2

Toner (A2) was obtained as in Example A1, except for using [Wax Dispersion A2] instead of [Wax Dispersion A1] added at the preparation of an oil phase.

### Example A3

Toner (A3) was obtained as in Example A1, except for using [Wax Dispersion A3] instead of the [Wax Dispersion A1] added at the preparation of an oil phase and using the [Kneaded Composite A2 of Modified Layered Inorganic Mineral and Binder Resin] instead of [Kneaded Composite A1 of Modified Layered Inorganic Mineral and Binder Resin].

### Example A4

Toner (A4) was obtained as in Example A1, except for using [Wax Dispersion A4] instead of [Wax Dispersion A1] added at the preparation of an oil phase and using [Kneaded Composite A3 of Modified Layered Inorganic Mineral and Binder Resin] instead of [Kneaded Composite A1 of Modified Layered Inorganic Mineral and Binder Resin].

### Example A5

Toner (A5) was obtained as in Example A1, except for using [Wax Dispersion A5] instead of [Wax Dispersion A1] added at the preparation of an oil phase and using [Kneaded Composite A4 of Modified Layered Inorganic Mineral and Binder Resin] instead of [Kneaded Composite A1 of Modified Layered Inorganic Mineral and Binder Resin].

### Comparative Example A1

Toner (A6) was obtained as in Example A1, except for using [Wax Dispersion A6] instead of [Wax Dispersion A1] added at the preparation of an oil phase.

### Comparative Example A2

Toner (A7) was obtained as in Example A1, except for using [Wax Dispersion A7] instead of [Wax Dispersion A1] added at the preparation of an oil phase.

### Comparative Example A3

Toner (A8) was obtained as in Example A1, except for using [Wax Dispersion A8] instead of [Wax Dispersion A1] added at the preparation of an oil phase and using [Kneaded Composite A3 of Modified Layered Inorganic Mineral and Binder Resin] instead of [Kneaded Composite A1 of Modified Layered Inorganic Mineral and Binder Resin].

### Comparative Example A4

Toner (A9) was obtained as in Example A1, except for using [Wax Dispersion A4] instead of [Wax Dispersion A1] added at the preparation of an oil phase and using [Kneaded Composite A4 of Modified Layered Inorganic Mineral and Binder Resin] instead of [Kneaded Composite A1 of Modified Layered Inorganic Mineral and Binder Resin].

### Comparative Example A5

Toner (A10) was obtained as in Example A1, except for using [Wax Dispersion A3] instead of the [Wax Dispersion A1] added at the preparation of an oil phase and using [Kneaded Composite A5 of Modified Layered Inorganic Mineral and Binder Resin] instead of [Kneaded Composite A1 of Modified Layered Inorganic Mineral and Binder Resin].

The physical properties of the toners obtained in Examples A1 to A5 and Comparative Examples A1 to A5 are collectively shown in Table 1.

TABLE 1

| | | | Keaded | | | | | | | | |
|---|---|---|---|---|---|---|---|---|---|---|---|
| | | | composite | | | | | Average | | | |
| | Toner | Wax No. | No. | Dv | Dv/Dn | SF-1 | SF-2 | circularity | A (μm) | B (μm) | A/B |
| Ex. A1 | Toner | 1 | 1 | 5.1 | 1.15 | 135 | 126 | 0.96 | 0.25 | 0.31 | 0.31 |
| | A1 | | | | | | | | | | |
| Ex. A2 | Toner | 2 | 1 | 4.4 | 1.14 | 160 | 146 | 0.95 | 0.16 | 0.31 | 0.52 |
| | A2 | | | | | | | | | | |
| Ex. A3 | Toner | 3 | 2 | 5.3 | 1.13 | 115 | 117 | 0.97 | 0.11 | 0.49 | 0.22 |
| | A3 | | | | | | | | | | |
| Ex. A4 | Toner | 4 | 3 | 5.7 | 1.22 | 136 | 127 | 0.96 | 0.46 | 0.24 | 1.92 |
| | A4 | | | | | | | | | | |
| Ex. A5 | Toner | 5 | 4 | 6.0 | 1.20 | 114 | 116 | 0.97 | 0.24 | 0.20 | 1.20 |
| | A5 | | | | | | | | | | |
| Com. A1 | Toner | 6 | 1 | 6.1 | 1.22 | 162 | 145 | 0.95 | 0.53 | 0.31 | 1.71 |
| | A6 | | | | | | | | | | |
| Com. A2 | Toner | 7 | 1 | 5.7 | 1.12 | 109 | 108 | 0.98 | 0.09 | 0.31 | 0.29 |
| | A7 | | | | | | | | | | |
| Com. A3 | Toner | 8 | 3 | 7.4 | 1.31 | 172 | 160 | 0.93 | 0.62 | 0.24 | 2.58 |
| | A8 | | | | | | | | | | |
| Com. A4 | Toner | 4 | 4 | 5.5 | 1.14 | 135 | 125 | 0.96 | 0.46 | 0.20 | 2.30 |
| | A9 | | | | | | | | | | |
| Com. A5 | Toner | 3 | 5 | 5.0 | 1.13 | 108 | 109 | 0.98 | 0.11 | 0.62 | 0.18 |
| | A10 | | | | | | | | | | |

In Table 1, “Ex.” denotes Example,
“Com.” denotes Comparative Example,
“A” denotes an average dispersed particle diameter A of wax, and
“B” denotes an average dispersed particle diameter B of modified layered inorganic material.

TABLE 2

| | | | | | Low- | Hot | Heat |
|---|---|---|---|---|---|---|---|
| | Image | | Background | Toner | temperature | offset | resistant |
| | density | Granularity | smearing | scattering | fixability | property | presevability |
| Ex. A1 | A | A | A | B | A | A | A |
| Ex. A2 | A | B | A | B | A | B | A |
| Ex. A3 | A | A | A | B | B | B | B |
| Ex. A4 | B | B | B | B | B | A | B |
| Ex. A5 | A | B | A | B | B | B | B |
| Com. A1 | D | D | C | D | B | C | C |
| Com. A2 | B | B | C | D | C | D | C |
| Com. A3 | D | D | D | D | D | C | D |
| Com. A4 | D | D | D | D | D | B | C |
| Com. A5 | C | C | C | D | C | D | D |

In Table 2, “Ex.” denotes Example, and
“Com.” denotes Comparative Example.

### Examples B1 to B6 and Comparative Examples B1 to B5

### Production Example B1

### (Preparation of Resin Fine Particle Dispersion)

In a reaction vessel equipped with a stirring rod and a thermometer, 683 parts of water, 11 parts of a sodium salt of a sulfate of a methacrylic acid-ethylene oxide adduct (Eleminol RS-30, made by Sanyo Chemical Industries, Ltd.), 83 parts of styrene, 83 parts of methacrylic acid, 110 parts of butyl acrylate and 1 part of ammonium persulfate were charged, and stirred at 400 rpm for 15 min to obtain a white emulsion. The emulsion was heated to a temperature in the system of 75° C. and allowed to react for 5 hours. Then, 30 parts of a 1% ammonium persulfate aqueous solution was added to the reaction product, and aged at 75° C. for 5 hours to obtain an aqueous dispersion of a vinyl resin (copolymer of styrene-methacrylic acid-butyl acrylate-sodium salt of a sulfate of a methacrylic acid-ethylene oxide adduct) [Resin Fine Particle Dispersion 1]. The volume average particle diameter obtained by measuring [Resin Fine Particle Dispersion 1] by an LA-920 was 105 nm. A resin fraction was isolated by drying part of [Resin Fine Particle Dispersion 1]. The resin fraction had a Tg of 59° C. and a weight-average molecular weight of 150,000.

### (Production of Low Molecular Polyester B1)

In a reaction vessel equipped with a cooling tube, a stirrer and a nitrogen introducing tube, 229 parts of an adduct of 2 moles of ethylene oxide to bisphenol A, 529 parts of an adduct of 3 moles of propylene oxide to bisphenol A, 208 parts of terephthalic acid, 46 parts of isophthalic acid and 2 parts of dibutyltin oxide were charged, allowed to react under ordinary pressure at 230° C. for 5 hours, and the reaction liquid was then further allowed to react under a reduced pressure of 10 mmHg to 15 mmHg for 5 hours; and thereafter, 44 parts of trimellitic anhydride was added to the reaction vessel and allowed to react at 180° C. under ordinary pressure for 2 hours to synthesize [Low Molecular Polyester B1]. A THF-soluble fraction of the obtained [Low Molecular Polyester B1] had a weight-average molecular weight (Mw) of 5,200, a glass transition temperature (Tg) of 45° C. and an acid value of 20 mg KOH/g.

### (Production of Prepolymer)

In a reaction vessel equipped with a cooling tube, a stirrer and a nitrogen introducing tube, 795 parts of an adduct of 2 moles of ethylene oxide to bisphenol A, 200 parts of isophthalic acid, 65 parts of terephthalic acid and 2 parts of dibutyltin oxide were charged, and polycondensated under ordinary pressure and a nitrogen gas flow at 210° C. for 8 hours. Then, the reaction was continued under a reduced pressure of 10 mmHg to 15 mmHg for 5 hours while being dehydrated; and the reaction product was cooled to 80° C., and allowed to react in ethyl acetate with 170 parts of isophorone diisocyanate for 2 hours to obtain [Prepolymer B1]. The obtained [Prepolymer B1] had a weight-average molecular weight of 5,000.

### (Production of Master Batch B1)

1,200 parts of water, 174 parts of BENTONE 57 made by Elementis Specialties, Inc. (an organic-modified bentonite, a quaternary ammonium cation-modified product) and 1570 parts of [Low Molecular Polyester B1] were mixed by a Henschel mixer (made by Mitsui Mining Co., Ltd.). The mixture was kneaded by a two-roll kneader at 150° C. for 30 min, then rolled and cooled, and pulverized by a pulverizer (made by Hosokawa Micron Corp.) to prepare a [Master Batch B1]. A modified layered inorganic mineral in the master batch had an average dispersed particle diameter of 0.4 μm, and the particles of 1 μm or more account for 2% by volume.

### (Preparation Example of Wax Dispersion B1)

70 parts of ethyl acetate, 25 parts of Polyester (B1), 5 parts of a carnauba wax (melting point: 82° C.) as a wax and further 60% by volume ratio of zirconia of 0.5 mm were charged and stirred by a Paint Conditioner No. 5400 (made by Red Devil Equipment Co. in U.S.) for 15 hours to obtain [Wax Dispersion B1]. The volume average particle diameter (average dispersed particle diameter) of wax dispersion particles contained in the obtained [Wax Dispersion is B1] was measured by a particle size distribution analyzer (“LA-920”; made by Horiba Ltd.) using the laser scattering method, and was 0.2 μm. The measurement by a flow-type particle image analyzer FPIA-3000S (made by Sysmex Corp.) revealed that the particles of 1 μm or more in the particles of 0.5 μm or more account for 10% by number. The particles of 0.800 or less in aspect ratio and of 1 μm or more account for 8% by number.

### (Preparation of Toner Material Oily Dispersion B1)

23.4 parts of [Prepolymer B1], 66.6 parts of [Low Molecular Polyester B1], 20 parts of [Master Batch B1] and 240 parts of [Wax Dispersion B1] as a releasing agent were charged in a beaker, and stirred and dissolved. Then separately, 20 parts of a carbon black pigment and 50 parts of ethyl acetate were charged in a bead mill, and dispersed for 30 min. The two liquids were mixed, stirred by a T.K. Homomixer at a rotation frequency of 12,000 rpm for 5 min, and then dispersed by a bead mill for 10 min. 2.9 parts of isophoronediamine was added to the dispersion, stirred by a T.K. Homomixer at a rotation frequency of 12,000 rpm for 5 min to obtain [Toner Material Oily Dispersion B1].

### Example B1

### (Production of Toner B1)

529.5 parts of ion exchange water, 70 parts of [Resin Fine Particle Dispersion B1] and 0.5 part of sodium dodecylbenzenesulfonate were charged in a beaker; 405.1 parts of [Toner Material Oily Dispersion B1] was added to the dispersion water while being stirred by a T.K. Homomixer at 12,000 rpm; and the dispersion was allowed to react while being stirred for 30 min. The content in the beaker was moved to a flask equipped with a cooling tube, and aged using a hot water vessel. The organic solvent was removed from the dispersion after the aging; and thereafter, the dispersion was filtered, washed, dried, and then air-classified to obtain a spherical toner base. 100 parts of the obtained base particles and 0.25 part of a charge control agent (Bontron E-84; made by Orient Chemical Industries, Ltd.) were charged in a Q-type mixer (made by Mitsui Mining Co., Ltd.), and mixed at a circumferential speed of turbine blades of 50 m/sec. Here, the mixing operation was carried out as a five-cycle operation of driving for 2 min and suspending for 1 min, and the total operation time was 10 min. Further, 0.5 parts of a hydrophobic silica (H2000; made by Clariant Japan) was added to the mixture and mixed. Here, the mixing operation was carried out at a circumferential speed of 15 m/sec as a five cycle operation of mixing for 30 sec and suspending for 1 min to obtain final [Toner B1]. With respect to the obtained [Toner B1], the volume average particle diameter, particle diameter distribution, low-temperature fixability, high-temperature offset resistance and image quality were evaluated.

### Production Example B2

### (Prepration of Wax Dispersion B2)

70 parts of ethyl acetate, 25 parts of Polyester (B1), 5 parts of a carnauba wax (melting point: 82° C.) as a wax and further 60% by volume ratio of zirconia of 0.5 mm were charged and stirred by a Paint Conditioner No. 5400 (made by Red Devil Equipment Co. in U.S.) for 13 hours to obtain [Wax Dispersion B2]. The volume average particle diameter (average dispersed particle diameter) of wax dispersion particles contained in the obtained [Wax Dispersion B2] was measured by a particle size distribution analyzer (“LA-920”; made by Horiba Ltd.) using the laser scattering method, and was 0.3 μm. The measurement by a flow-type particle image analyzer FPIA-3000S (made by Sysmex Corp.) revealed that the particles of 1 μm or more in the particles of 0.5 μm or more account for 12% by number. The particles of 0.800 or less in aspect ratio and of 1 μm or more account for 10% by number.

### (Preparation of Toner Material Oily Dispersion B2)

23.4 parts of [Prepolymer B1], 66.6 parts of [Low Molecular Polyester B1], 20 parts of [Master Batch B1] and 240 parts of [Wax Dispersion B2] as a releasing agent were charged in a beaker, and stirred and dissolved. Then separately, 20 parts of a carbon black pigment and 50 parts of ethyl acetate were charged in a bead mill, and dispersed for 30 min. The two liquids were mixed, stirred by a T.K. Homomixer at a rotation frequency of 12,000 rpm for 5 min, and then dispersed by a bead mill for 10 min. 2.9 parts of isophoronediamine was added to the dispersion, stirred by a T.K. Homomixer at a rotation frequency of 12,000 rpm for 5 min to obtain [Toner Material Oily Dispersion B2].

### Example B2

### (Production of Toner B2)

[Toner B2] was obtained as in the production of [Toner B1], except for using 405.1 parts of [Toner Material Oily Dispersion B2] instead of 405.1 parts of [Toner Material Oily Dispersion B1] in (Production of Toner B1).

### Production Example B3

### (Preparation of Wax Dispersion B3)

70 parts of ethyl acetate, 25 parts of Polyester (B1), 5 parts of a carnauba wax (melting point: 82° C.) as a wax and further 60% by volume ratio of zirconia of 0.5 mm were charged and stirred by a Paint Conditioner No. 5400 (made by Red Devil Equipment Co. in U.S.) for 11 hours to obtain [wax dispersion B3]. The volume average particle diameter (average dispersed particle diameter) of wax dispersion particles contained in the obtained [Wax Dispersion B3] was measured by a particle size distribution analyzer (“LA-920”; made by Horiba Ltd.) using the laser scattering method, and was 0.4 μm. The measurement by a flow-type particle image analyzer FPIA-3000S (made by Sysmex Corp.) revealed that the particles of 1 μm or more in the particles of 0.5 μm or more account for 15% by number. The particles of 0.800 or less in aspect ratio and of 1 μm or more account for 13% by number.

### (Preparation of Toner Material Oily Dispersion B3)

23.4 parts of [Prepolymer B1], 66.6 parts of [Low Molecular Polyester B1], 20 parts of [Master Batch B1] and 240 parts of [Wax Dispersion B3] as a releasing agent were charged in a beaker, and stirred and dissolved. Then separately, 20 parts of a carbon black pigment and 50 parts of ethyl acetate were charged in a bead mill, and dispersed for 30 min. The two liquids were mixed, stirred by a T.K. Homomixer at a rotation frequency of 12,000 rpm for 5 min, and then dispersed by a bead mill for 10 min. 2.9 parts of isophoronediamine was added to the dispersion, stirred by a T.K. Homomixer at a rotation frequency of 12,000 rpm for 5 min to obtain [Toner Material Oily Dispersion B3].

### Example B3

### (Production of Toner B3)

[Toner B3] was obtained as in the production of [Toner B1], except for using 405.1 parts of the [Toner Material Oily Dispersion B3] instead of 405.1 parts of [Toner Material Oily Dispersion B1] in (Production of Toner B1).

### Production Example B4

### (Preparation of Wax Dispersion B4)

70 parts of ethyl acetate, 25 parts of Polyester (B1), 5 parts of a carnauba wax (melting point: 82° C.) as a wax and further 60% by volume ratio of zirconia of 0.5 mm were charged and stirred by a Paint Conditioner No. 5400 (made by Red Devil Equipment Co. in U.S.) for 10 hours to obtain [Wax Dispersion B4]. The volume average particle diameter (average dispersed particle diameter) of wax dispersion particles contained in the obtained [wax dispersion B4] was measured by a particle size distribution analyzer (“LA-920”; made by Horiba Ltd.) using the laser scattering method, and was 0.5 μm. The measurement by a flow-type particle image analyzer FPIA-3000S (made by Sysmex Corp.) revealed that the particles of 1 μm or more in the particles of 0.5 μm or more account for 18% by number. The particles of 0.800 or less in aspect ratio and of 1 μm or more account for 17% by number.

### (Preparation of Toner Material Oily Dispersion B4)

23.4 parts of [Prepolymer B1], 66.6 parts of [Low Molecular Polyester B1], 20 parts of [Master Batch B1] and 240 parts of [Wax Dispersion B4] as a releasing agent were charged in a beaker, and stirred and dissolved. Then separately, 20 parts of a carbon black pigment and 50 parts of ethyl acetate were charged in a bead mill, and dispersed for 30 min. The two liquids were mixed, stirred by a T.K. Homomixer at a rotation frequency of 12,000 rpm for 5 min, and then dispersed by a bead mill for 10 min. 2.9 parts of isophoronediamine was added to the dispersion, stirred by a T.K. Homomixer at a rotation frequency of 12,000 rpm for 5 min to obtain [Toner Material Oily Dispersion B4].

### Example B4

### (Production of Toner B4)

[Toner B4] was obtained as in the production of [Toner B1], except for using 405.1 parts of [Toner Material Oily Dispersion B4] instead of 405.1 parts of [Toner material Oily Dispersion B1] in (Production of Toner B1).

### Production Example B5

### (Preparation of Wax Dispersion B5)

70 parts of ethyl acetate, 25 parts of Polyester (B1), 5 parts of a carnauba wax (melting point: 82° C.) as a wax and further 60% by volume ratio of zirconia of 0.5 mm were charged and stirred by a Paint Conditioner No. 5400 (made by Red Devil Equipment Co. in U.S.) for 9 hours to obtain [Wax Dispersion B5]. The volume average particle diameter (average dispersed particle diameter) of wax dispersion particles contained in the obtained [Wax Dispersion B5] was measured by a particle size distribution analyzer (“LA-920”; made by Horiba Ltd.) using the laser scattering method, and was 0.5 μm. The measurement by a flow-type particle image analyzer FPIA-3000S (made by Sysmex Corp.) revealed that the particles of 1 μm or more in the particles of 0.5 μm or more account for 20% by number. The particles of 0.800 or less in aspect ratio and of 1 μm or more account for 19% by number.

### (Preparation of Toner Material Oily Dispersion B5)

23.4 parts of [Prepolymer B1], 66.6 parts of [Low Molecular Polyester B1], 20 parts of [Master Batch B1] and 240 parts of [Wax Dispersion B5] as a releasing agent were charged in a beaker, and stirred and dissolved. Then separately, 20 parts of a carbon black pigment and 50 parts of ethyl acetate were charged in a bead mill, and dispersed for 30 min. The two liquids were mixed, stirred by a T.K. Homomixer at a rotation frequency of 12,000 rpm for 5 min, and then dispersed by a bead mill for 10 min. 2.9 parts of isophoronediamine was added to the dispersion, stirred by a T.K. Homomixer at a rotation frequency of 12,000 rpm for 5 min to obtain [Toner Material Oily Dispersion B5].

### Example B5

### (Production of Toner B5)

[Toner B5] was obtained as in the production of [Toner B1], except for using 405.1 parts of [Toner Material Oily Dispersion B5] instead of 405.1 parts of [Toner Material Oily Dispersion Liquid B1] in (Production of Toner B1).

### Production Example B6

### (Preparation of Wax Dispersion B6)

70 parts of ethyl acetate, 25 parts of Polyester (B1), 5 parts of a carnauba wax (melting point: 82° C.) as a wax and further 60% by volume ratio of zirconia of 0.3 mm were charged and stirred by a Paint Conditioner No. 5400 (made by Red Devil Equipment Co. in U.S.) for 9 hours to obtain [Wax Dispersion B6]. The volume average particle diameter (average dispersed particle diameter) of wax dispersion particles contained in the obtained [Wax Dispersion B6] was measured by a particle size distribution analyzer (“LA-920”; made by Horiba Ltd.) using the laser scattering method, and was 0.4 μm. The measurement by a flow-type particle image analyzer FPIA-3000S (made by Sysmex Corp.) revealed that the particles of 1 μm or more in the particles of 0.5 μm or more account for 20% by number. The particles of 0.800 or less in aspect ratio and of 1 μm or more account for 14% by number.

### (Preparation of Toner Material Oily Dispersion B6)

23.4 parts of [Prepolymer B1], 66.6 parts of [Low molecular polyester B1], 20 parts of [Master Batch B1] and 240 parts of [Wax Dispersion B6] as a releasing agent were charged in a beaker, and stirred and dissolved. Then separately, 20 parts of a carbon black pigment and 50 parts of ethyl acetate were charged in a bead mill, and dispersed for 30 min. The two liquids were mixed, stirred by a T.K. Homomixer at a rotation frequency of 12,000 rpm for 5 min, and then dispersed by a bead mill for 10 min. 2.9 parts of isophoronediamine was added to the dispersion, stirred by a T.K. Homomixer at a rotation frequency of 12,000 rpm for 5 min to obtain [Toner Material Oily Dispersion B6].

### Example B6

### (Production of Toner B6)

[Toner B6] was obtained as in the production of [Toner B1], except for using 405.1 parts of [Toner Material Oily Dispersion B6] instead of 405.1 parts of [Toner Material Oily Dispersion B1] in (Production of Toner B1).

### Production Example B7

### (Preparation of Wax Dispersion B7)

70 parts of ethyl acetate, 25 parts of Polyester (B1), 5 parts of a carnauba wax (melting point: 82° C.) as a wax and further 60% by volume ratio of zirconia of 0.5 mm were charged and stirred by a Paint Conditioner No. 5400 (made by Red Devil Equipment Co. in U.S., in U.S.) for 6 hours to obtain [Wax Dispersion B7]. The volume average particle diameter (average dispersed particle diameter) of wax dispersion particles contained in the obtained [Wax Dispersion B7] was measured by a particle size distribution analyzer (“LA-920”; made by Horiba Ltd.) using the laser scattering method, and was 0.7 μm. The measurement by a particle number count/particle size distribution analyzer (AccuSizer 780; made by Particle Sizing Systems Co., Ltd. in U.S.) using the light blocking system revealed that the particles of 1 μm or more in the particles of 0.5 μm or more account for 22% by number. The particles of 0.800 or less in aspect ratio and of 1 μm or more account for 21% by number.

### (Preparation of Toner Material Oily Dispersion B7)

23.4 parts of [Prepolymer B1], 66.6 parts of [Low Molecular Polyester B1], 20 parts of [Master Batch B1] and 240 parts of [Wax Dispersion B7] as a releasing agent were charged in a beaker, and stirred and dissolved. Then separately, 20 parts of a carbon black pigment and 50 parts of ethyl acetate were charged in a bead mill, and dispersed for 30 min. The two liquids were mixed, stirred by a T.K. Homomixer at a rotation frequency of 12,000 rpm for 5 min, and then dispersed by a bead mill for 10 min. 2.9 parts of isophoronediamine was added to the dispersion, stirred by a T.K. Homomixer at a rotation frequency of 12,000 rpm for 5 min to obtain [Toner Material Oily Dispersion B7].

### Comparative Example B1

### (Production of Toner B7)

[Toner B7] was obtained as in the production of [Toner B1], except for using 405.1 parts of [Toner Material Oily Dispersion B7] instead of 405.1 parts of [Toner Material Oily Dispersion B1] in (Production of Toner B1).

### Production Example B8

### (Preparation of Wax Dispersion B8)

70 parts of ethyl acetate, 25 parts of Polyester (B1), 5 parts of a carnauba wax (melting point: 82° C.) as a wax and further 60% by volume ratio of zirconia of 0.5 mm were charged and stirred by a Paint Conditioner No. 5400 (made by Red Devil Equipment Co. in U.S.) for 8 hours to obtain [Wax Dispersion B8]. The volume average particle diameter (average dispersed particle diameter) of wax dispersion particles contained in the obtained [Wax Dispersion B8] was measured by a particle size distribution analyzer (“LA-920”; made by Horiba Ltd.) using the laser scattering method, and was 0.6 μm. The measurement by a particle number count/particle size distribution analyzer (AccuSizer 780; made by Particle Sizing Systems Co., Ltd. in U.S.) using the light blocking system revealed that the particles of 1 μm or more in the particles of 0.5 μm or more account for 19% by number. The particles of 0.800 or less in aspect ratio and of 1 μm or more account for 18% by number.

### (Preparation of Toner Material Oily Dispersion B8)

23.4 parts of [Prepolymer B1], 66.6 parts of [Low Molecular Polyester B1], 20 parts of [Master Batch B1] and 240 parts of [Wax Dispersion B8] as a releasing agent were charged in a beaker, and stirred and dissolved. Then separately, 20 parts of a carbon black pigment and 50 parts of ethyl acetate were charged in a bead mill, and dispersed for 30 min. The two liquids were mixed, stirred by a T.K. Homomixer at a rotation frequency of 12,000 rpm for 5 min, and then dispersed by a bead mill for 10 min. 2.9 parts of isophoronediamine was added to the dispersion, stirred by a T.K. Homomixer at a rotation frequency of 12,000 rpm for 5 min to obtain [Toner Material Oily Dispersion B8].

### Comparative Example B2

### (Production of Toner B8)

[Toner B8] was obtained as in the production of [Toner B1], except for using 405.1 parts of [Toner Material Oily Dispersion B8] instead of 405.1 parts of [Toner Material Oily Dispersion B1] in (Production of Toner B1).

### Production Example B9

### (Preparation of Wax Dispersion B9)

70 parts of ethyl acetate, 25 parts of Polyester (B1), 5 parts of a carnauba wax (melting point: 82° C.) as a wax and further 60% by volume ratio of zirconia of 1 mm were charged and stirred by a Paint Conditioner No. 5400 (made by Red Devil Equipment Co. in U.S., in U.S.) for 13 hours to obtain [Wax Dispersion B9]. The volume average particle diameter (average dispersed particle diameter) of wax dispersion particles contained in the obtained [Wax Dispersion B9] was measured by a particle size distribution analyzer (“LA-920”; made by Horiba Ltd.) using the laser scattering method, and was 0.3 μm. The measurement by a particle number count/particle size distribution analyzer (AccuSizer 780; made by Particle Sizing Systems Co., Ltd. in U.S.) using the light blocking system revealed that the particles of 1 μm or more in the particles of 0.5 μm or more account for 22% by number. The particles of 0.800 or less in aspect ratio and of 1 μm or more account for 21% by number.

### (Preparation of Toner Material Oily Dispersion B9)

23.4 parts of [Prepolymer B1], 66.6 parts of [Low Molecular Polyester B1], 20 parts of [Master Batch B1] and 240 parts of [Wax Dispersion B9] as a releasing agent were charged in a beaker, and stirred and dissolved. Then separately, 20 parts of a carbon black pigment and 50 parts of ethyl acetate were charged in a bead mill, and dispersed for 30 min. The two liquids were mixed, stirred by a T.K. Homomixer at a rotation frequency of 12,000 rpm for 5 min, and then dispersed by a bead mill for 10 min. 2.9 parts of isophoronediamine was added to the dispersion, stirred by a T.K. Homomixer at a rotation frequency of 12,000 rpm for 5 min to obtain [Toner Material Oily Dispersion B9].

### Comparative Example B3

### (Production of Toner B9)

[Toner B9] was obtained as in the production of [Toner B1], except for using 405.1 parts of [Toner Material Oily Dispersion B9] instead of 405.1 parts of [Toner Material Oily Dispersion B1] in (Production of Toner B1).

### Production Example B10

### (Preparation of Wax Dispersion B10)

70 parts of ethyl acetate, 25 parts of Polyester (B1), 5 parts of a carnauba wax (melting point: 82° C.) as a wax and further 60% by volume ratio of zirconia of 1 mm were charged and stirred by a Paint Conditioner No. 5400 (made by Red Devil Equipment Co. in U.S., in U.S.) for 11 hours to obtain [Wax Dispersion B10]. The volume average particle diameter (average dispersed particle diameter) of wax dispersion particles contained in the obtained [Wax Dispersion B10] was measured by a particle size distribution analyzer (“LA-920”; made by Horiba Ltd.) using the laser scattering method, and was 0.4 μm. The measurement by a particle number count/particle size distribution analyzer (AccuSizer 780; made by Particle Sizing Systems Co., Ltd. in U.S.) using the light blocking system revealed that the particles of 1 μm or more in the particles of 0.5 μm or more account for 23% by number. The particles of 0.800 or less in aspect ratio and of 1 μm or more account for 22% by number.

### (Preparation of Toner Material Oily Dispersion B10)

23.4 parts of [Prepolymer B1], 66.6 parts of [Low Molecular Polyester B1], 20 parts of [Master Batch B1] and 240 parts of [Wax Dispersion B10] as a releasing agent were charged in a beaker, and stirred and dissolved. Then separately, 20 parts of a carbon black pigment and 50 parts of ethyl acetate were charged in a bead mill, and dispersed for 30 min. The two liquids were mixed, stirred by a T.K. Homomixer at a rotation frequency of 12,000 rpm for 5 min, and then dispersed by a bead mill for 10 min. 2.9 parts of isophoronediamine was added to the dispersion, stirred by a T.K. Homomixer at a rotation frequency of 12,000 rpm for 5 min to obtain [Toner Material Oily Dispersion B10].

### Comparative Example B4

### (Production of Toner B10)

[Toner B10] was obtained as in the production of [Toner B1], except for using 405.1 parts of [Toner Material Oily Dispersion B10] instead of 405.1 parts of [Toner Material Oily Dispersion B1] in (Production of Toner B1).

### Production Example B11

### (Preparation of Wax Dispersion B11)

70 parts of ethyl acetate, 25 parts of Polyester (B1), 5 parts of a carnauba wax (melting point: 82° C.) as a wax and further 60% by volume ratio of zirconia of 1 mm were charged and stirred by a Paint Conditioner No. 5400 (made by Red Devil Equipment Co. in U.S.) for 9 hours to obtain [Wax Dispersion B11]. The volume average particle diameter (average dispersed particle diameter) of wax dispersion particles contained in the obtained [Wax Dispersion B11] was measured by a particle size distribution analyzer (“LA-920”; made by Horiba Ltd.) using the laser scattering method, and was 0.5 μm. The measurement by a particle number count/particle size distribution analyzer (AccuSizer 780; made by Particle Sizing Systems Co., Ltd. in U.S.) using the light blocking system revealed that the particles of 1 μm or more in the particles of 0.5 μm or more account for 25% by number. The particles of 0.800 or less in aspect ratio and of 1 μm or more account for 24% by number.

### (Preparation of Toner Material Oily Dispersion B11)

23.4 parts of [Prepolymer B1], 66.6 parts of [Low Molecular Polyester B1], 20 parts of [Master Batch B1] and 240 parts of [Wax Dispersion B11] as a releasing agent were charged in a beaker, and stirred and dissolved. Then separately, 20 parts of a carbon black pigment and 50 parts of ethyl acetate were charged in a bead mill, and dispersed for 30 min. The two liquids were mixed, stirred by a T.K. Homomixer at a rotation frequency of 12,000 rpm for 5 min, and then dispersed by a bead mill for 10 min. 2.9 parts of isophoronediamine was added to the dispersion, stirred by a T.K. Homomixer at a rotation frequency of 12,000 rpm for 5 min to obtain [Toner Material Oily Dispersion B11].

### Comparative Example B5

### (Production of Toner B11)

[Toner B11] was obtained as in the production of [Toner B1], except for using 405.1 parts of [Toner Material Oily Dispersion B11] instead of 405.1 parts of [Toner Material Oily Dispersion B1] in (Production of Toner B1).

The properties of the wax dispersions used in Examples B1 to B11 described above are shown in Table 3.

TABLE 3

| | Average | Content of particles of | Content of particles |
|---|---|---|---|
| | dispersed | 1 μm or more in | having an aspect |
| | particle | particles of 0.5 μm | ratio of 0.800 |
| | diameter | or more [% by | or less and a |
| | [μm] | number] | diameter of 1 μm or |
| Wax diepersion | 0.2 | 10 | 8 |
| B1 | | | |
| Wax diepersion | 0.3 | 12 | 10 |
| B2 | | | |
| Wax diepersion | 0.4 | 15 | 13 |
| B3 | | | |
| Wax diepersion | 0.5 | 18 | 17 |
| B4 | | | |
| Wax diepersion | 0.5 | 20 | 19 |
| B5 | | | |
| Wax diepersion | 0.4 | 20 | 14 |
| B6 | | | |
| Wax diepersion | 0.7 | 22 | 21 |
| B7 | | | |
| Wax diepersion | 0.6 | 19 | 18 |
| B8 | | | |
| Wax diepersion | 0.3 | 22 | 21 |
| B9 | | | |
| Wax diepersion | 0.4 | 23 | 22 |
| B10 | | | |
| Wax diepersion | 0.5 | 25 | 24 |
| B11 | | | |

The properties of the toners obtained in Examples B1 to B11 described above are shown in Table 4.

TABLE 4

| | Particle size distribution | | | | | | | |
|---|---|---|---|---|---|---|---|---|
| | | | Proportion of | | | | | |
| | | | particles of 2 μm | | | | Acid value | Tg |
| | Dv [μm] | Dv/Dn | or less | SF-1 | SF-2 | Circularity | [KOHmg/g] | [° C.] |
| Toner B1 | 5.3 | 1.13 | 2.2 | 135 | 126 | 0.96 | 18.5 | 53.2 |
| Toner B2 | 5.2 | 1.13 | 2.1 | 130 | 120 | 0.96 | 18.4 | 52.4 |
| Toner B3 | 5.2 | 1.14 | 3.4 | 134 | 122 | 0.96 | 18.2 | 53.5 |
| Toner B4 | 5.0 | 1.15 | 3.0 | 128 | 120 | 0.96 | 18.4 | 52.6 |
| Toner B5 | 5.4 | 1.15 | 3.5 | 129 | 122 | 0.96 | 18.2 | 52.2 |
| Toner B6 | 5.3 | 1.14 | 3.0 | 135 | 123 | 0.96 | 18.5 | 53.4 |
| Toner B7 | 5.7 | 1.22 | 5.5 | 118 | 115 | 0.97 | 18.0 | 52.3 |
| Toner B8 | 5.5 | 1.20 | 5.4 | 119 | 114 | 0.97 | 18.1 | 52.1 |
| Toner B9 | 5.3 | 1.18 | 6.3 | 120 | 119 | 0.97 | 18.2 | 53.0 |
| Toner B10 | 5.2 | 1.19 | 6.2 | 119 | 118 | 0.97 | 18.4 | 52.8 |
| Toner B11 | 5.4 | 1.20 | 5.4 | 118 | 117 | 0.97 | 18.3 | 52.9 |

The toners obtained in Examples B1 to B6 and Comparative Examples B1 to B5 were evaluated as follows. The results of the performance evaluations are shown in Tables 5-1 and 5-2.

TABLE 5-1

| | | Image | | | | | | |
|---|---|---|---|---|---|---|---|---|
| | Image | granularity | Background | Toner | Cleaning | Charge quantity | | |
| | density | and sharpness | smearing | scattering | ability | 15 sec. | 5 min. | 10 min. |
| Ex. B1 | A | A | A | B | B | −43.5 | −45.1 | −46.2 |
| Ex. B2 | A | A | A | B | B | −41.3 | −44.3 | −40.2 |
| Ex. B3 | A | A | B | B | B | −40.3 | −42.9 | −41.8 |
| Ex. B4 | B | B | B | B | B | −38.2 | −40.8 | −40.0 |
| Ex. B5 | B | B | B | B | B | −37.2 | −39.4 | −40.4 |
| Ex. B6 | A | A | B | B | B | −41.2 | −43.8 | −44.3 |
| Com. B1 | D | D | D | D | B | −33.3 | −35.3 | −34.5 |
| Com. B2 | D | C | C | C | B | −37.5 | −39.1 | −38.8 |
| Com. B3 | C | D | C | C | B | −39.1 | −40.3 | −42.9 |
| Com. B4 | C | D | C | C | B | −36.2 | −38.7 | −40.8 |
| Com. B5 | D | D | D | D | B | −32.1 | −34.5 | −36.4 |

TABLE 5-2

| | Charging | Charging | Minimum | | |
|---|---|---|---|---|---|
| | stability at high | stability at low | fixing | | |
| | temperature | temperature | temperature | Hot offset | Heat resistant |
| | and high | and low | [° C.] | [° C.] | preservability |
| Ex. B1 | B | B | 130: A | 210: A | B |
| Ex. B2 | B | B | 140: B | 210: A | B |
| Ex. B3 | B | B | 140: B | 210: A | B |
| Ex. B4 | B | B | 140: B | 210: A | B |
| Ex. B5 | B | B | 140: B | 210: A | B |
| Ex. B6 | B | B | 140: B | 210: A | B |
| Com. B1 | C | C | 150: B′ | 180: C | D |
| Com. B2 | C | C | 150: B′ | 180: C | D |
| Com. B3 | C | C | 150: B′ | 200: B | C |
| Com. B4 | C | C | 150: B′ | 190: B′ | C |
| Com. B5 | C | C | 150: B′ | 180: C | C |

In Tables 5-1 and 5-2, “Ex.” denotes Example, and “Com.” denotes Comparative Example.

The toner evaluation items and evaluation methods in Examples and Comparative Examples are shown below.

### [Preparation of Measurement Samples]

### (The Average Dispersed Particle Diameter of the Modified Layered Inorganic Mineral in the Kneaded Composite of the Modified Layered Inorganic Mineral and the Binder Resin)

### Examples A1 to A6 and Comparative Examples A1 to A5

A kneaded composite and a binder resin in a proportion of the amount of an organic cation-modified layered inorganic mineral in the kneaded composite of the modified layered inorganic mineral and a binder resin/the amount of the binder resin used in the kneaded composite= 1/10 were charged in an ethyl acetate solution in which a dispersant (Disperbyk-167 made by BYK Chemie GmbH) of 5% by mass was dissolved. Here, the total amount of the kneaded composite and the binder resin was adjusted at 5% by mass. The adjusted sample was stirred for 12 hours.

### (The Average Dispersed Particle Diameter of the Modified Layered Inorganic Mineral in the Master Batch)

### Examples B1 to B6 and Comparative Examples B1 to B5

A master batch and a binder resin in a proportion of the amount of an organic cation-modified layered inorganic mineral in a master batch/the amount of a binder resin used in the master batch= 1/10 were charged in an ethyl acetate solution in which a dispersant (Disperbyk-167 made by BYK Chemie GmbH) of 5% by mass was dissolved. Here, the total amount of the master batch and the binder resin was adjusted at 5% by mass. The adjusted sample was stirred for 12 hours.

### [Measurement of Dispersed Particle Diameters]

The adjusted sample described above was measured using a laser Doppler particle size distribution measuring instrument.

The measuring method was as follows.
Measuring Instrument: nanotrac UPA-150EX (made by Nikkiso Co., Ltd.)
Method: (1) Measurement conditions:

Distribution indication: volume

Number of channels: 52

Measurement time: 15 sec

| | |
|---|---|
| Refraction index: 1.54 | Temperature: 25° C. |
| Particle shape: non-sphere | Viscosity (CP): 0.441 |
| Refraction index of solvent: 1.37 | Solvent: ethyl acetate |

(2) A diluted sample liquid to be measured was added using a dropper or syringe such that the sample loading on the measuring instrument was in the range of 1 to 100 while watching the sample Loading.

### (Acid Value (mg KOH/g))

An acid value was measured according to the method prescribed in JIS K0070, but in the case of a sample which did not dissolve in the solvent, as a solvent, dioxane, tetrahydrofuran or the like was used.

The acid value was determined specifically by the following procedure.
Measuring Instrument: automatic potentiometric titrator DL-53 Titrator (made by Mettler-Toledo International Inc.)
Using electrodes: DG113-SC (made by Mettler-Toledo International Inc.)
Analysis software: LabX Light Version 1.00.000
Calibration of the instrument: Using a mixed solvent of 120 ml of toluene and 30 ml of ethanol
Measurement temperature: 23° C.

The measurement conditions are as follows.

Stir

| | |
|---|---|
| Speed [%] | 25 |
| Time [s] | 15 |

EQP titration
Titrant/Sensor

| | |
|---|---|
| Titrant | CH₃ONa |
| Concentration [mol/L] | 0.1 |
| Sensor | DG115 |
| Unit of measurement | mV |

Predispensing to volume

| | |
|---|---|
| Volume [mL] | 1.0 |
| Wait time [s] | 0 |

| Titrant addition | Dynamic |
|---|---|
| dE(set) [mV] | 8.0 |
| dV(min) [mL] | 0.03 |
| dV(max) [mL] | 0.5 |

| Measure mode | Equilibrium controlled |
|---|---|
| dE [mV] | 0.5 |
| dt [s] | 1.0 |
| t(min) [s] | 2.0 |
| t(max) [s] | 20.0 |

Recognition

| | |
|---|---|
| Threshold | 100.0 |
| Steepest jump only | No |
| Range | No |
| Tendency | None |

Termination

| | |
|---|---|
| at maximum volume [mL] | 10.0 |
| at potential | No |
| at slope | No |
| after number EQPs | Yes |
| n = 1 | |
| comb. termination conditions | No |

Evaluation

| | |
|---|---|
| Procedure | Standard |
| Potential 1 | No |
| Potential 2 | No |
| Stop for reevaluation | No |

### (Measuring Method of an Acid Value)

An acid value was measured under the following conditions according to the measuring method described in JIS K0070-1992. Sample preparation: 0.5 g of a toner (0.3 g of its ethyl acetate-soluble reaction) was added to 120 ml of toluene, and stirred at room temperature (23° C.) for about 10 hours for dissolution. 30 ml of ethanol was further added to make a sample solution.

The acid value could be calculated by the instrument described above, but was specifically calculated as follows. The sample solution was titrated with a previously standardized N/10-potassium hydroxide alcohol solution and an acid value was determined from the consumption amount of the alcoholic potassium hydroxide solution by the following calculation.

Acid value=KOH (ml)×N×56.1/weight of a sample

(wherein N denotes a factor of the N/10 KOH)

### (Glass Transition Temperature Tg (° C.))

A glass transition temperature was measured by a Rigaku THERMOFLEX TG8110 made by Rigaku Denki Service Center Co., Ltd. under a condition of a temperature rising rate of 10° C./min.

The measuring method of Tg will be outlined. As a measuring instrument of Tg, a TG-DSC System TAS-100 made by Rigaku Denki Service Center Co., Ltd. was used.

First, about 10 mg of a sample was put in an aluminum-made sample container, mounted on a holder unit, and placed in an electric furnace. The sample was heated from room temperature to 150° C. at a temperature rising rate of 10° C./min, then allowed to stand at 150° C. for 10 min, cooled to room temperature, allowed to stand for 10 min, and again heated under a nitrogen atmosphere to 150° C. at a temperature rising rate of 10° C./min for the DSC measurement. Tg was calculated from a contact point of a tangential line of an endothermic curve near Tg and a base line by using an analysis system in the TAS-100 system.

### (Image Density)

By using a digital full-color copying machine (imagioColor 2800 made by Ricoh Co., Ltd.), 150,000 sheets of image charts of an image area of 50% in a monochrome mode were running output; is then, solid images were output on 6000-type paper made by Ricoh Co., Ltd.; and then, the image density was measured by an XRite (made by X-Rite, Inc.).

The measurements were performed individually for four colors and the average was determined. The case of this value of less than 1.2 is defined as “D”; that of 1.2 or more and of less than 1.4, as “C”; that of 1.4 or more and of less than 1.8, as “B”; and that of 1.8 or more and of less than 2.2, as “A”.

### (Image Granularity and Sharpness)

By using a digital full-color copying machine (imagioColor 2800 made by Ricoh Co., Ltd.), photographic images in monochrome were output and the degree of the granularity and sharpness were visually evaluated. In order from a good evaluation, the evaluations were defined as “A” for the degree nearly equal to offset printing; “B” for that slightly worse than offset printing; “C” for that considerably worse than offset printing; and “D” for that near to conventional electrophotographic images (very bad).

### (Background Smearing)

By using a digital full-color copying machine (imagioColor 2800 made by Ricoh Co., Ltd.), 30,000 sheets of image charts of an image area of 50% in a monochrome mode were running output; then blank paper images were made to suspend during development; a developer on a photoreceptor after the development was transferred to a tape; and a difference in image density between the transferred tape and an untransferred tape was measured by a 938 Spectrodensitometer (made by X-Rite, Inc.). A smaller difference in image density means a better background smearing; and the background smears were ranked as “A”, “B”, “C” and “D” from a good one.

### (Toner Scattering)

By using a digital full-color copying machine (imagioColor 2800 made by Ricoh Co., Ltd.), after 50,000 sheets were continuously printed, the degree of contamination of a toner inside the machine was confirmed. The scattering in a level of no problem was defined as “B”; that in which the toner was found, but there was no problem in use, as “C”; and that in which the machine was remarkably contaminated, which caused a problem, as “D”.

### (Cleanability)

A residual toner after transfer on a photoreceptor having passed through a cleaning process was shifted to blank paper with a Scotch Tape (made by Sumitomo 3M Co., Ltd.); and the shifted paper was measured by a Macbeth reflection densitometer RD514. The cleanability having a difference between the shifted blank paper and a blank paper of 0.01 or less was defined as “B” (good); and that exceeding 0.01 was defined as “D” (bad).

### (Evaluation of Charge Quantity)

### 1) 15-sec Stirring Charge Quantity

10 g of each obtained toner and 100 g of a ferrite carrier were charged in a stainless steel pot to 30% of its volume in an environment of a temperature of 28° C. and a humidity of 80%, stirred at a stirring rate of 100 rpm for 15 sec, and measured for the charge quantity (μC/g) of the developer by a [TB-200 made by Toshiba Chemical Corp].

The charge quantity of the toner was measured by the blow-off method.

### 2) 5-min Stirring Charge Quantity

The charge quantity when the mixture was stirred for 5 min was measured as in 1).

### 3) 10-min Stirring Charge Quantity

The charge quantity when the mixture was stirred for 10 min was measured as in 1).

### (Charge Stability)

### (1) Charge Stability at a High Temperature Environment and a High Humidity Environment

In an environment of a temperature of 40° C. and a humidity of 90%, while 100,000 sheets of image charts of an image area of 7% in a monochrome mode were running output by a digital full-color copying machine (imagioColor 2800 made by Ricoh Co., Ltd.), a developer was partially sampled at every 1,000 sheets and the charge quantity was measured by the blow-off method to evaluate the charge stability. The case of a change in the charge quantity of 5 μc/g or less was defined as “B”; that of 10 μc/g or less, as “C”; and that exceeding 10 μc/g, as “D”.

### (2) Charge Stability at a Low Temperature Environment and a Low Humidity Environment

In an environment of a temperature of 10’ C. and a humidity of 15%, while 100,000 sheets of image charts of an image area of 7% in a monochrome mode were running output by a digital full-color copying machine (imagioColor 2800 made by Ricoh Co., Ltd.), a developer was partially sampled at every 1,000 sheets and the charge quantity was measured by the blow-off method to evaluate the charge stability. The case of a change in the charge quantity of 5 μc/g or less was defined as “B”; that of 10 μc/g or less, as “C”; and that exceeding 10 μc/g, as “D”.

The measurements of the charge quantity by the blow-off method in (1) and (2) were performed as follows.

10 g of each obtained toner and 100 g of a ferrite carrier were charged in a stainless steel pot to 30% of its volume in a testing room at a temperature of 20° C. and a humidity of 50%, stirred at a stirring rate of 100 rpm for 10 min, and measured for the charge quantity (μC/g) of the developer by a [TB-200 made by Toshiba Chemical Corp].

### (Evaluation of Fixability)

6200-type paper made by Ricoh Co., Ltd. was loaded on a copying machine in which the fixing portion of the copying machine MF2200 made by Ricoh Co., Ltd. using a Teflon® roller as a fixing roller is remodeled, and copying tests were conducted. By changing the fixing temperatures, the cold offset temperature (fixing lower limit temperature) and the hot offset temperature (hot offset resistance temperature) were determined. Conventional low-temperature fixing toners have a fixing lower limit temperature of about 140° C. to 150° C. Here, the evaluation conditions of low temperature fixing were set at a linear speed of paper feeding of 120 mm/sec to 150 mm/sec, a surface pressure of 1.2 Kgf/cm² and a nip width of 3 mm; and the evaluation conditions of high temperature offset were set at a linear speed of paper feeding of 50 mm/sec, a surface pressure of 2.0 Kgf/cm² and a nip width of 4.5 mm. The evaluation of each characteristic was performed according to the following standard.

### Low-Temperature Fixability (5-Stage Evaluation)

Good “A”: lower than 140° C., “B”: 140° C. to 149° C., “B′”: 150° C. to 159° C., “C”: 160° C. to 170° C., “D”: 170° C. or higher Bad

Hot-offset property (5-stage evaluation)

Good “A”: 201° C. or higher, “B”: 200° C. to 191° C., “B′”: 190° C. to 181° C., “C”: 180° C. to 171° C., “D”: 170° C. or lower Bad

### (Heat Resistant Preservability)

After a toner was preserved at 50° C. for 8 hours, the toner was sifted through a sieve of 42-mesh for 2 min, and a residual rate on the metallic mesh was defined as the heat resistant preservability. A toner having a better heat resistant preservability has a less residual rate. The evaluation was conducted in the following 4 stages.
“D”: 30% or more
“C”: 20% to 30%
“B”: 10% to 20%
“A”: less than 10%

What is claimed is:

1. A toner for developing a latent electrostatic image, comprising:
toner particles,
wherein each toner particle comprises at least:
a releasing agent; and
a modified layered inorganic mineral in which at least a part of ions present in between layers of a layered inorganic mineral is replaced with an organic ion,
wherein the toner satisfies one of the following conditions (1) and (2):
(1) the releasing agent has an average dispersed particle diameter of 0.1 μm to 0.5 μm in the toner particle, and the toner has a ratio A/B of 0.2 to 2.0 where A denotes the average dispersed particle diameter of the releasing agent and B denotes an average dispersed particle diameter of the modified layered inorganic mineral; and
(2) the releasing agent has an average dispersed particle diameter of 0.1 μm to 0.5 μm, a proportion of the dispersed particles of the releasing agent having a diameter of 1 μm or more in the dispersed particles of the releasing agent having a diameter of 0.5 μm or more is 20% by number or less, and
wherein the toner is obtained by a method comprising:
dissolving or dispersing at least a binder resin or a precursor of a binder resin, a colorant, the releasing agent, and the modified layered inorganic mineral in an organic solvent so as to prepare an oil phase;
dispersing the oil phase in an aqueous medium so as to prepare an emulsified dispersion; and
removing the solvent from the emulsified dispersion so as to yield the toner particles.

2. The toner according to claim 1, wherein the toner is obtained by a method comprising:
dissolving or dispersing at least a polymer having a site reactive with a compound having an active hydrogen group, a binder resin or a precursor of a binder resin, a colorant, the releasing agent, a kneaded composite of the binder resin and a modified layered inorganic mineral in which at least a part of ions present in between layers of a layered inorganic mineral is replaced with an organic ion, in an organic solvent so as to prepare an oil phase;
dispersing the oil phase in an aqueous medium containing resin fine particles so as to allow the polymer to react; and
removing the solvent after or during the reaction so as to yield the toner particles.

3. The toner according to claim 1, wherein the modified layered inorganic mineral has an average dispersed particle diameter of 0.1 μm to 0.55 μm.

4. The toner according to claim 1, wherein the modified layered inorganic mineral is added to the oil phase as a kneaded lo composite with the binder resin, and the modified layered inorganic mineral has an average dispersed particle diameter of 0.1 μm to 0.55 μm in the kneaded composite.

5. The toner according to claim 1, wherein the precursor of the binder resin is a modified polyester resin, and
wherein a compound which is capable of being elongated or crosslinked with the modified polyester resin is dissolved in the oil phase, the oil phase is dispersed in the aqueous medium in the presence of fine particle dispersant so as to prepare the emulsified dispersion, the modified polyester is allowed to proceed a crosslinking reaction or an elongation reaction in the emulsified dispersion, and the organic solvent is removed from the emulsified dispersion so as to yield the toner particles.

6. The toner according to claim 1, wherein the toner comprises 0.05% by mass to 5.0% by mass of the modified layered inorganic mineral.

7. The toner according to claim 1, wherein the modified layered inorganic mineral is a layered inorganic mineral in which at least a part of metallic cations present in between layers of the layered inorganic mineral is replaced with an organic cation.

8. The toner according to claim 1, wherein the toner has a volume average particle diameter Dv of 3.0 μm to 7.0 μm, and a ratio Dv/Dn of 1.00 to 1.30, where Dv denotes the volume average particle diameter and Dn denotes a number average particle diameter.

9. The toner according to claim 1, wherein the dispersed particles of the releasing agent having a particle diameter of 0.5 μm or more has an aspect ratio of the particle of 0.800 or less, and a proportion of the dispersed particles of the releasing agent having a particle diameter of 1 μm or more in the dispersed particles of the releasing agent having a particle diameter of 0.5 μm or more is 20% by number or less.

10. The toner according to claim 1, wherein the toner comprises 1% by mass to 10% by mass of the releasing agent.

11. The toner according to claim 1, wherein the modified layered inorganic mineral is added as a kneaded composite with the binder resin to the oil phase, the modified layered inorganic mineral has an average dispersed particle diameter of 0.1 μm to 0.55 μm in the kneaded composite, and the modified layered inorganic mineral having a particle diameter of 1 μm or more accounts for 15% by volume or less in the kneaded composite.

12. The toner according to claim 1, wherein the toner has an average circularity of 0.93 to 0.97.

13. The toner according to claim 1, wherein the toner particles having a circularity of 0.950 or less account for 20% by number to 80% by number in the entire toner particles.

14. The toner according to claim 1, wherein the toner has a shape factor SF-1 of 110 to 200 and a shape factor SF-2 of 110 to 300.

15. The toner according to claim 7, wherein the organic cation is a quaternary ammonium ion.

16. The toner according to claim 1, wherein the toner particles having a diameter of 2 μm or less account for 1% by number to 20% by number in the entire toner particles.

17. The toner according to claim 1, wherein the binder resin comprises a polyester resin.

18. The toner according to claim 2, wherein the polymer having a site reactive with a compound having an active hydrogen group has a weight-average molecular weight of 3,000 to 20,000.

19. A toner manufacturing method, comprising:
dissolving or dispersing at least a binder resin or a precursor of a binder resin, a colorant, a releasing agent, and a modified layered inorganic mineral in which at least a part of ions present in between layers of a layered inorganic mineral is replaced with an organic ion in an organic solvent so as to prepare an oil phase;
dispersing the oil phase in an aqueous medium so as to prepare an emulsified dispersion; and
removing the solvent from the emulsified dispersion so as to yield the toner particles,
wherein the toner satisfies one of the following conditions (1) and (2):
(1) the releasing agent has an average dispersed particle diameter of 0.1 μm to 0.5 μm in the toner particle, and the toner has a ratio A/B of 0.2 to 2.0 where A denotes the average dispersed particle diameter of the releasing agent and B denotes an average dispersed particle diameter of the modified layered inorganic mineral; and
(2) the releasing agent has an average dispersed particle diameter of 0.1 μm to 0.5 μm, a proportion of the dispersed particles of the releasing agent having a diameter of 1 μm or more in the dispersed particles of the releasing agent having a diameter of 0.5 μm or more is 20% by number or less.

20. An image forming apparatus, comprising:
a transferring unit configured to transfer a toner image formed of a toner and carried on a toner image bearing member to a transfer material; and
a cleaning unit configured to clean the toner remained on the toner image bearing member after the transferring, by using a blade,
wherein the toner comprises:
toner particles,
wherein each toner particle comprises at least:
a releasing agent; and
a modified layered inorganic mineral in which at least a part of ions present in between layers of a layered inorganic mineral is replaced with an organic ion,
wherein the toner satisfies one of the following conditions (1) and (2):
(1) the releasing agent has an average dispersed particle diameter of 0.1 μm to 0.5 μm in the toner particle, and the toner has a ratio A/B of 0.2 to 2.0 where A denotes the average dispersed particle diameter of the releasing agent and B denotes an average dispersed particle diameter of the modified layered inorganic mineral; and
(2) the releasing agent has an average dispersed particle diameter of 0.1 μm to 0.5 μm, a proportion of the dispersed particles of the releasing agent having a diameter of 1 μm or more in the dispersed particles of the releasing agent having a diameter of 0.5 μm or more is 20% by number or less, and
wherein the toner is obtained by a method comprising:
dissolving or dispersing at least a binder resin or a precursor of a binder resin, a colorant, the releasing agent, and the modified layered inorganic mineral in an organic solvent so as to prepare an oil phase;
dispersing the oil phase in an aqueous medium so as to prepare an emulsified dispersion; and
removing the solvent from the emulsified dispersion so as to yield the toner particles.
